(19) United States
(12) Patent Application Publication
(10) Pub. No.: US 2021/0053233 A1
(43) Pub. Date: Feb. 25, 2021

(54) INFORMATION PROCESSING APPARATUS, INFORMATION PROCESSING METHOD, AND INFORMATION PROCESSING PROGRAM

(71) Applicant: NEC Corporation, Tokyo (JP)

(72) Inventors: Kanako HATAYAMA, Tokyo (JP); Dai KINNO, Tokyo (JP); Emi FUKUDOME, Tokyo (JP)

(73) Assignee: NEC Corporation, Tokyo (JP)

(21) Appl. No.: 16/977,702

(22) PCT Filed: Feb. 15, 2019
(86) PCT No.: PCT/JP2019/005650

§ 371 Date: Sep. 2, 2020

(30) Foreign Application Priority Data
Mar. 5, 2018 (JP) 2018-039056

(51) Int. Cl. B25J 13/08; G06K 9/00; G06Q 10/08; G06Q 30/00

(52) U.S. Cl. CPC B25J 13/089; B25J 13/087; G06Q 30/01; G06Q 10/087; G06K 9/00671

(57) ABSTRACT

A plurality of robots cooperate to cope with problems occurring outside robots. An information processing apparatus comprises an acquirer that acquires information from a first robot, an analyzer that analyzes the acquired information,
a determiner that determines a second robot to cooperate with the first robot and work contents of the second robot from an analysis result of the analyzer, and an instructor that instructs the work contents to the second robot based on a determination result of the determiner.

This application is based upon and claims the benefit of priority from Japanese patent application No. 2018-039056, filed on Mar. 5, 2018, the disclosure of which is incorporated herein in its entirety by reference.

### TECHNICAL FIELD

The present invention relates to an information processing apparatus, an information processing method, and an information processing program.

### BACKGROUND ART

In the above technical field, patent literature 1 discloses a technique in which when a sudden abnormality occurs in a robot which is executing a service flow, a robot which is not providing a service flow and can take over the service flow is searched for under conditions such as the retaining capability of a robot, and then takes over the service flow. Patent literature 2 discloses a technique in which when the position of a robot which is executing a service falls within a predetermined range determined with reference to a service switching position, a service takeover robot is selected from robots which are not executing services.

### CITATION LIST

### Patent Literature

Patent literature 1: Japanese Patent Laid-Open No. 2007-249801
Patent literature 2: Japanese Patent Laid-Open No. 2007-245317

### SUMMARY OF THE INVENTION

### Technical Problem

In the techniques described in the above literatures, however, a plurality of robots cannot cooperate to cope with a problem occurring outside a robot.

The present invention provides a technique of solving the above-described problem.

### Solution to Problem

One example aspect of the present invention provides an information processing apparatus comprising:

an acquirer that acquires information from a first robot;

an analyzer that analyzes the acquired information;

a determiner that determines a second robot to cooperate with the first robot and work contents of the second robot based on an analysis result of the analyzer; and

an instructor that instructs the work contents to the second robot based on a determination result of the determiner.

Another example aspect of the present invention provides an information processing method comprising:

acquiring information from a first robot;

analyzing the acquired information;

determining a second robot to cooperate with the first robot and work contents of the second robot based on an analysis result in the analyzing; and

instructing the work contents to the second robot based on a determination result in the determining.

Still other example aspect of the present invention provides an information processing program for causing a computer to execute a method, comprising:

acquiring information from a first robot;

analyzing the acquired information;

determining a second robot to cooperate with the first robot and work contents of the second robot based on an analysis result in the analyzing; and

instructing the work contents to the second robot based on a determination result in the determining.

### Advantageous Effects of Invention

According to the present invention, a plurality of robots can cooperate to cope with a problem occurring outside a robot.

### BRIEF DESCRIPTION OF DRAWINGS

FIG. 1 is a block diagram showing the arrangement of an information processing apparatus according to the first example embodiment of the present invention;

FIG. 2 is a view showing an example of processing by an information processing apparatus according to the second example embodiment of the present invention;

FIG. 3 is a block diagram showing the arrangement of the information processing apparatus according to the second example embodiment of the present invention;

FIG. 4A is a table showing an example of a robot performance table provided in the information processing apparatus according to the second example embodiment of the present invention;

FIG. 4B is a table showing an example of a problem solving table provided in the information processing apparatus according to the second example embodiment of the present invention;

FIG. 5 is a block diagram showing the hardware arrangement of the information processing apparatus according to the second example embodiment of the present invention;

FIG. 6 is a flowchart for explaining the processing procedure of the information processing apparatus according to the second example embodiment of the present invention;

FIG. 7 is a view showing an example of processing by an information processing apparatus according to the third example embodiment of the present invention;

FIG. 8 is a block diagram showing the arrangement of the information processing apparatus according to the third example embodiment of the present invention;

FIG. 9 is a table showing an example of a problem solving table provided in the information processing apparatus according to the third example embodiment of the present invention;

FIG. 10 is a block diagram showing the hardware arrangement of the information processing apparatus according to the third example embodiment of the present invention;

FIG. 11 is a flowchart for explaining the processing procedure of the information processing apparatus according to the third example embodiment of the present invention;

FIG. 12 is a view showing an example of processing by an information processing apparatus according to the fourth example embodiment of the present invention;

FIG. 13 is a block diagram showing the arrangement of the information processing apparatus according to the fourth example embodiment of the present invention;

FIG. 14 is a table showing an example of a problem solving table provided in the information processing apparatus according to the fourth example embodiment of the present invention;

FIG. 15 is a block diagram showing the hardware arrangement of the information processing apparatus according to the fourth example embodiment of the present invention;

FIG. 16 is a flowchart for explaining the processing procedure of the information processing apparatus according to the fourth example embodiment of the present invention;

FIG. 17 is a view showing an example of processing by an information processing apparatus according to the fifth example embodiment of the present invention;

FIG. 18 is a block diagram showing the arrangement of the information processing apparatus according to the fifth example embodiment of the present invention;

FIG. 19 is a table showing an example of a problem solving table provided in the information processing apparatus according to the fifth example embodiment of the present invention;

FIG. 20 is a block diagram showing the hardware arrangement of the information processing apparatus according to the fifth example embodiment of the present invention;

FIG. 21 is a flowchart for explaining the processing procedure of the information processing apparatus according to the fifth example embodiment of the present invention;

FIG. 22 is a view showing an example of processing by an information processing apparatus according to the sixth example embodiment of the present invention;

FIG. 23 is a block diagram showing the arrangement of the information processing apparatus according to the sixth example embodiment of the present invention;

FIG. 24 is a table showing an example of a problem solving table provided in the information processing apparatus according to the sixth example embodiment of the present invention;

FIG. 25 is a block diagram showing the hardware arrangement of the information processing apparatus according to the sixth example embodiment of the present invention;

FIG. 26 is a flowchart for explaining the processing procedure of the information processing apparatus according to the sixth example embodiment of the present invention;

FIG. 27 is a view showing an example of processing by an information processing apparatus according to the seventh example embodiment of the present invention;

FIG. 28 is a block diagram showing the arrangement of the information processing apparatus according to the seventh example embodiment of the present invention;

FIG. 29 is a table showing an example of a problem solving table provided in the information processing apparatus according to the seventh example embodiment of the present invention;

FIG. 30 is a block diagram showing the hardware arrangement of the information processing apparatus according to the seventh example embodiment of the present invention;

FIG. 31 is a flowchart for explaining the processing procedure of the information processing apparatus according to the seventh example embodiment of the present invention;

FIG. 32 is a view showing an example of processing by an information processing apparatus according to the eighth example embodiment of the present invention;

FIG. 33 is a block diagram showing the arrangement of the information processing apparatus according to the eighth example embodiment of the present invention;

FIG. 34 is a table showing an example of a problem solving table provided in the information processing apparatus according to the eighth example embodiment of the present invention;

FIG. 35 is a block diagram showing the hardware arrangement of the information processing apparatus according to the eighth example embodiment of the present invention;

FIG. 36 is a flowchart for explaining the processing procedure of the information processing apparatus according to the eighth example embodiment of the present invention;

FIG. 37 is a view showing an example of processing by an information processing apparatus according to the ninth example embodiment of the present invention;

FIG. 38 is a block diagram showing the arrangement of the information processing apparatus according to the ninth example embodiment of the present invention;

FIG. 39 is a table showing an example of a problem solving table provided in the information processing apparatus according to the ninth example embodiment of the present invention;

FIG. 40 is a block diagram showing the hardware arrangement of the information processing apparatus according to the ninth example embodiment of the present invention;

FIG. 41 is a flowchart for explaining the processing procedure of the information processing apparatus according to the ninth example embodiment of the present invention;

FIG. 42 is a view showing an example of processing by an information processing apparatus according to the 10th example embodiment of the present invention;

FIG. 43 is a block diagram showing the arrangement of the information processing apparatus according to the 10th example embodiment of the present invention;

FIG. 44 is a table showing an example of a problem solving table provided in the information processing apparatus according to the 10th example embodiment of the present invention;

FIG. 45 is a block diagram showing the hardware arrangement of the information processing apparatus according to the 10th example embodiment of the present invention;

FIG. 46 is a flowchart for explaining the processing procedure of the information processing apparatus according to the 10th example embodiment of the present invention;

FIG. 47 is a view showing an example of processing by an information processing apparatus according to the 11th example embodiment of the present invention;

FIG. 48 is a block diagram showing the arrangement of the information processing apparatus according to the 11th example embodiment of the present invention;

FIG. 49 is a table showing an example of a problem solving table provided in the information processing apparatus according to the 11th example embodiment of the present invention;

FIG. 50 is a block diagram showing the hardware arrangement of the information processing apparatus according to the 11th example embodiment of the present invention;

FIG. 51 is a flowchart for explaining the processing procedure of the information processing apparatus according to the 11th example embodiment of the present invention;

FIG. 52 is a view showing an example of processing by an information processing apparatus according to the 12th example embodiment of the present invention;

FIG. 53 is a block diagram showing the arrangement of the information processing apparatus according to the 12th example embodiment of the present invention;

FIG. 54 is a table showing an example of a problem solving table provided in the information processing apparatus according to the 12th example embodiment of the present invention;

FIG. 55 is a block diagram showing the hardware arrangement of the information processing apparatus according to the 12th example embodiment of the present invention;

FIG. 56 is a flowchart for explaining the processing procedure of the information processing apparatus according to the 12th example embodiment of the present invention; and

FIG. 57 is a table showing an example of a problem solving table provided in an information processing apparatus according to the 13th example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

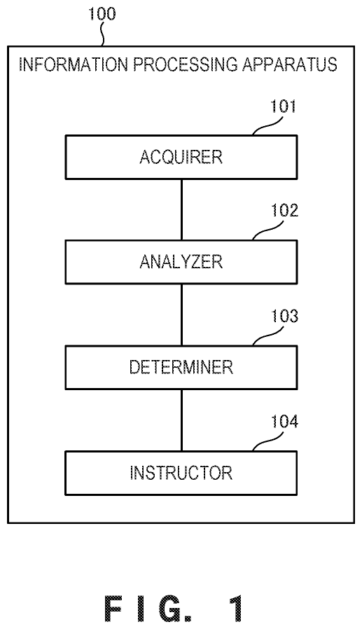

An information processing apparatus 100 according to the first example embodiment of the present invention will be described with reference to FIG. 1. The information processing apparatus 100 is an apparatus that analyzes information acquired from a robot and determines another robot to cooperate with the robot.

As shown in FIG. 1, the information processing apparatus 100 comprises an acquirer 101, an analyzer 102, a determiner 103, and an instructor 104. The acquirer 101 acquires information from a first robot. The analyzer 102 analyzes the acquired information. The determiner 103 determines a second robot to cooperate with the first robot and work contents of the second robot based on an analysis result of the analyzer 102. The instructor 104 instructs the work contents to the second robot based on a determination result of the determiner 103.

According to this example embodiment, a plurality of robots can cooperate to cope with problems occurring outside robots.

### Second Example Embodiment

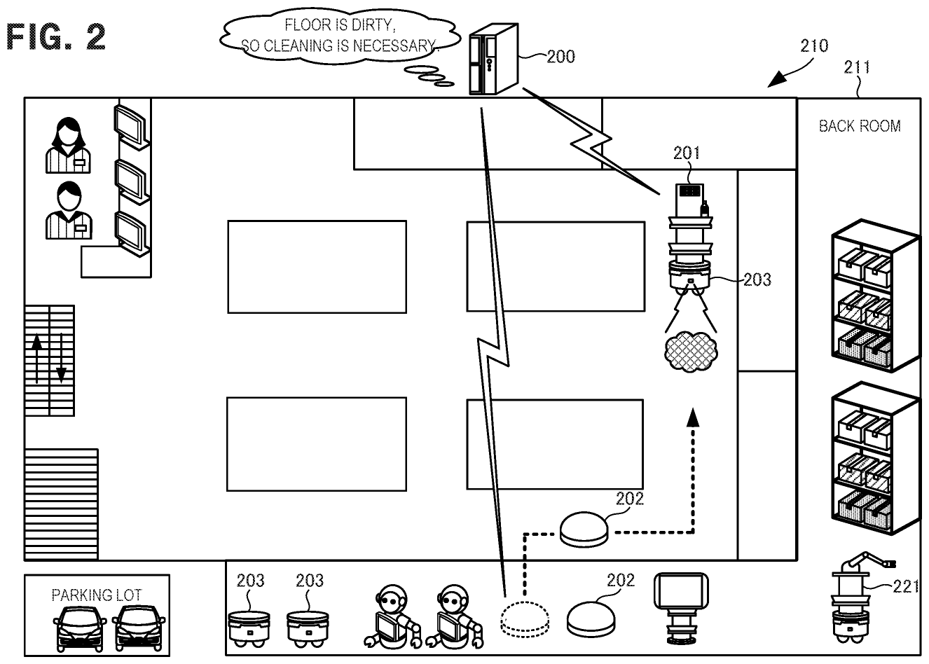

An information processing apparatus according to the second example embodiment of the present invention will be described next with reference to FIGS. 2 to 6. FIG. 2 is a view showing an example of processing by an information processing apparatus 200 as a server according to this example embodiment.

As shown in FIG. 2, assume, for example, that a conveying robot 201 having a function of conveying, from a back room 211 to a predetermined display shelf in a store 210, products to be arranged on the shelf is performing a conveying work of products in the store 210.

The conveying robot 201 working in the store 210 captures an image of its periphery by a camera for movement in the store 210 and a work in the store 210. The conveying robot 201 transmits, as image information, the peripheral image captured by the camera to the information processing apparatus 200. The information processing apparatus 200 receives and acquires the image information from the conveying robot 201 working in the store 210.

The information processing apparatus 200 analyzes the acquired image information, and detects, from an analysis result, problems occurring in the store 210. The information processing apparatus 200 detects a dirt of a floor in this example embodiment. Upon detecting the dirt of the floor, the information processing apparatus 200 detects position information concerning the position of the dirt of the floor in the store 210. In addition, the information processing apparatus 200 determines work contents necessary to remove the dirt of the floor.

Then, the information processing apparatus 200 judges whether the conveying robot 201 working in the store 210 can clean the dirt of the floor. That is, the information processing apparatus 200 judges whether the conveying robot 201 can solve the problem of the dirt of the floor occurring in the store 210.

Since the conveying robot 201 cannot remove the dirt of the floor, the information processing apparatus 200 judges that the conveying robot 201 cannot remove the dirt of the floor. The information processing apparatus 200 determines or selects a cleaning robot 202 as a robot that can remove the dirt of the floor.

The information processing apparatus 200 instructs the work contents for removing the dirt to the selected cleaning robot 202. For example, if the floor is dirty by a liquid or the like, the work contents instructed to the selected cleaning robot 202 by the information processing apparatus 200 includes that the floor is wiped off to remove the liquid. That is, the cleaning robot 202 standing by in the back room 211 moves into the store 210 to remove the dirt.

Note that the cleaning robot 202 selected or instructed by the information processing apparatus 200 is not limited to the cleaning robot 202 standing by in the back room 211, and may be the cleaning robot 202 working or moving in the store 210. As described above, the information processing apparatus 200 solves the problem occurring outside the conveying robot 201 or the like by making the conveying robot 201 and the cleaning robot 202 cooperate with each other.

The information processing apparatus 200 selects the cleaning robot 202 in comprehensive consideration of, for example, information of the proximity from the position of the dirt, the capability of the cleaning robot 202, whether the cleaning robot 202 is working, the level of the dirt, and the like. However, the information to be considered is not limited to them.

If, for example, there is trash or the like on the floor, the information processing apparatus 200 selects a cleaning robot that can pick up the trash or the like, a cleaning robot that can sweep, and the like. Then, the information processing apparatus 200 instructs work contents for picking up or collecting the trash to these cleaning robots.

Note that a cart portion 203 of the conveying robot 201 shown in FIG. 2 is shared with other robots. That is, in this example embodiment, a robot portion having a predetermined function and the cart portion 203 are combined to form one robot. The cart portion 203 is used as a part for moving the robot having the predetermined function. For example, although the conveying robot 201 has the camera, this camera may be provided in the robot portion or the cart portion 203. If the camera is provided in the cart portion 203, every robots can share the camera. Alternatively, a robot including a moving part corresponding to the cart portion 203 may be used. The same situation applies to robots having other functions to be described below in other example embodiments. In this example embodiment, one cleaning robot 202 moves to make the floor clean. However, the number of robots moving is not limited to one, but a plurality of robots may move. The same situation applies to robots having other functions to be described below in other example embodiments.

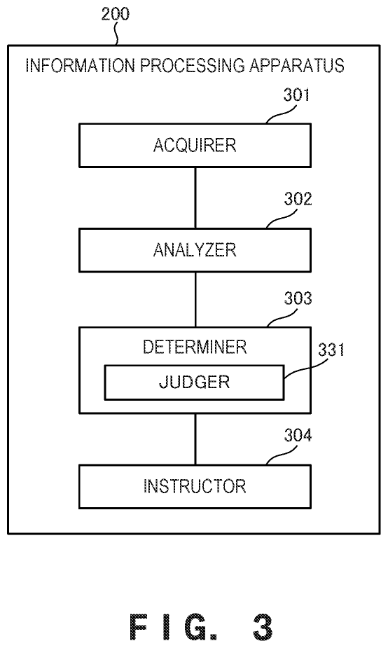

FIG. 3 is a block diagram showing the arrangement of the information processing apparatus 200 according to this example embodiment. The information processing apparatus 200 includes an acquirer 301, an analyzer 302, a determiner 303, and an instructor 304. Furthermore, the determiner 303 includes a judger 331.

For example, the acquirer 301 acquires image information from a robot working or moving in the store 210. The acquired image information is information about an image captured by a camera provided in each robot. A robot that executes a work or the like in the store 210 is an autonomous mobile robot or the like (referred to as a mobile robot thereinafter), and can freely move around in the store 210. The mobile robot is a robot that can move with understanding the peripheral status using the image captured by the camera, a result of detection by an obstacle detection sensor, and the like. As described above, the mobile robot moves to a place where a predetermined work is necessary, and then executes the predetermined work. Note that the acquirer 301 may acquire, in addition to the image information, identification information for identifying the robot and position information indicating the position of the robot. The position information of the robot may be detected from the acquired image information.

The analyzer 302 analyzes the acquired image information to recognize or detect a problem occurring in the store 210. The analyzer 302 detects, based on the image information, a problem occurring in the store 210 such as a dirt of a floor or a trash. Whether the floor is dirty is determined by, for example, comparing past image information and current image information at the same position in the store 210.

If, for example, the color of the floor is different between the past image information and the current image information, the analyzer 302 determines that the floor is dirty. Trash in the store 210 is also determined by comparing the past image information and the current image information. If, for example, an object that does not exist in the past image information exists in the current image information, the analyzer 302 determines that there is trash in the store 210. Note that if the analyzer 302 cannot determine a dirt of the floor or a trash, the acquired image information may be transmitted to an operator to make the operator determine that.

To solve the problem occurring in the store 210, the determiner 303 determines, based on the analysis result of the analyzer 302, another robot to cooperate with the robot that has transmitted the image information to the information processing apparatus 200. Before determining another robot to cooperate with the robot, that is, determining another robot for solving the problem occurring in the store 210, the determiner 303 makes the judger 331 judge whether or not the robot that has transmitted the image information can solve the problem.

The judger 331 judges whether or not the robot that has transmitted the image information to the information processing apparatus 200 can solve the problem occurring in the store 210 and detected by the analyzer 302. Based on, for example, the performance of the robot that has transmitted the image information, the judger 331 judges whether or not the robot can solve the problem occurring in the store 210.

If the judger 331 judges that the robot that has transmitted the image information to the information processing apparatus 200 cannot solve the problem occurring in the store 210, the determiner 303 determines or selects another robot that can solve the problem. Based on the performance of each robot and the like, the determiner 303 selects a robot that can solve the problem.

If the detected problem is a dirt of the floor, the determiner 303 selects the cleaning robot 202 having a function of wiping off a dirt of a floor. If the detected problem is trash, the determiner 303 selects a cleaning robot 221 having a function of picking up trash.

The instructor 304 instructs position information of the problem and work contents for solving the problem to the robot 202 or 221 selected by the determiner 303. If the floor is dirty, the instructor 304 instructs a cleaning method such as a work of wiping off the dirt or a work of sweeping the floor to the cleaning robot 202. If there is trash, the instructor 304 instructs a cleaning method such as a work of picking up the trash to the cleaning robot 221.

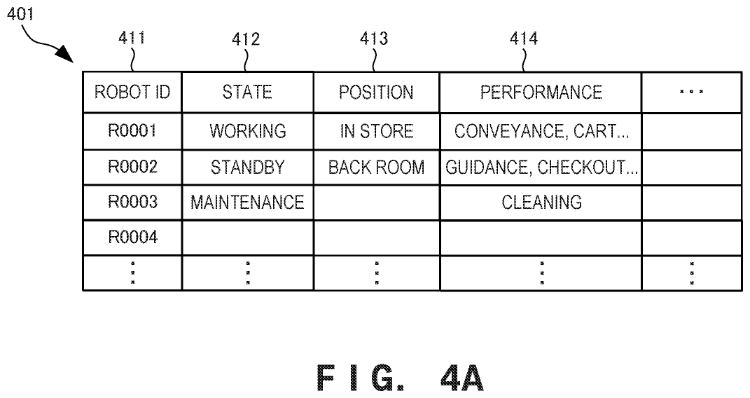

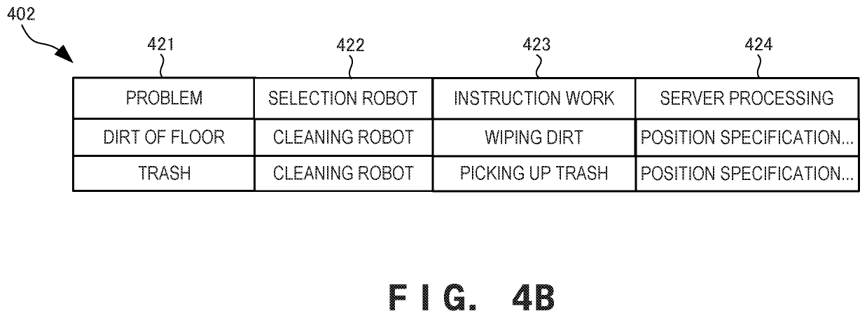

FIG. 4A is a table showing an example of a robot performance table 401 provided in the information processing apparatus according to this example embodiment. The robot performance table 401 stores, in association with a robot ID (IDentifier) 411, a state 412, a position 413, and performance 414. The robot ID 411 is an identifier for identifying a robot. The state 412 indicates the current state (working, standby, maintenance, or the like) of the robot. The position 413 indicates the current position of the robot. The performance 414 is information concerning the retaining performance or function of the robot. For example, the information processing apparatus 200 selects a robot for solving a problem occurring in the store 210 with reference to the robot performance table 401.

FIG. 4B is a table showing a problem solving table 402 provided in the information processing apparatus according to this example embodiment. The problem solving table 402 stores, in association with a problem 421, a selection robot 422, an instruction work 423, and server processing 424. The problem 421 indicates a problem occurring in the store 210. The selection robot 422 indicates an example of a robot to be selected for the occurred problem. The instruction work 423 indicates an example of work contents to be instructed to the selected robot. The server processing 424 indicates an example of processing performed in the information processing apparatus 200 as the server. For example, the information processing apparatus 200 solves a problem occurring in the store 210 with reference to the problem solving table 402.

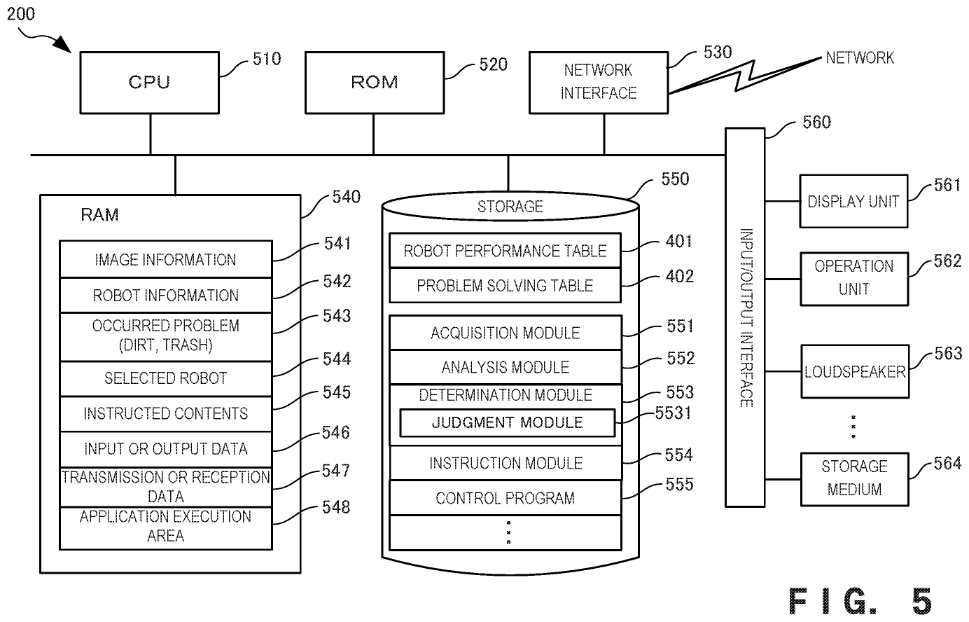

FIG. 5 is a block diagram showing the hardware arrangement of the information processing apparatus 200 according to this example embodiment. A CPU (Central Processing Unit) 510 is an arithmetic control processor, and implements the functional components of the information processing apparatus 200 shown in FIG. 3 by executing a program. A ROM (Read Only Memory) 520 stores permanent data such as initial data and a program, and other programs. A network interface 530 communicates with another apparatus or the like via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads transmission/reception data in or from the area of a RAM (Random Access Memory) 540. It is desirable to provide a DMAC (Direct Memory Access Controller) (not shown) for transferring data between the RAM 540 and a storage 550. An input/output interface 560 desirably includes a CPU independent of the CPU 510, and writes or reads input/output data in or from the area of the RAM 540. Therefore, the CPU 510 recognizes that data has been received by the RAM 540 or transferred to the RAM 540, and processes the data. The CPU 510 prepares a processing result in the RAM 540, and delegates succeeding transmission or transfer to the network interface 530, the DMAC, or the input/output interface 560.

The RAM 540 is a random access memory used as a temporary storage work area by the CPU 510. An area to store data necessary for implementation of the example embodiment is allocated to the RAM 540. Image information 541 is, for example, information concerning an image captured by a robot working or moving in the store 210 and acquired from the robot. Robot information 542 is information concerning the state, performance, function, position, and the like of the robot. An occurred problem 543 is a problem occurring in the store 210, for example, a dirt of floor or a trash. A selected robot 544 is a robot selected to solve the occurred problem. Instructed contents 545 are work contents including a position and a work instructed to the selected robot. These data are loaded from, for example, the robot performance table 401 and the problem solving table 402.

Input or output data 546 is data input or output via the input/output interface 560. Transmission or reception data 547 is data transmitted or received via the network interface 530. The RAM 540 includes an application execution area 548 used to execute various application modules.

The storage 550 stores a database, various parameters, or the following data or programs necessary for implementation of this example embodiment. The storage 550 stores the robot performance table 401 and the problem solving table 402. The robot performance table 401 is the table, shown in FIG. 4A, for managing the relationship among the robot ID 411, the performance 414, and the like. The problem solving table 402 is the table, shown in FIG. 4B, for managing the relationship among the occurred problem 421, the selection robot 422, and the like. The storage 550 further stores an acquisition module 551, an analysis module 552, a determination module 553, and an instruction module 554. The determination module 553 further stores a judgment module 5531.

The acquisition module 551 is a module that acquires image information from a robot. The analysis module 552 is a module that analyzes the image information to detect a problem occurring in the store 210. The determination module 553 is a module that determines or selects, based on a judgment result of the judgment module 5531, a robot to solve the detected problem. The judgment module 5531 is a module that judges whether or not the robot that has transmitted the image information to the information processing apparatus 200 can solve the detected problem. The instruction module 554 is a module that instructs work contents for solving the problem to the robot that can solve the detected problem. These modules 551 to 554 and 5531 are loaded to the application execution area 548 of the RAM 540 and executed by the CPU 510. A control program 555 is a program for controlling the overall information processing apparatus 200.

The input/output interface 560 interfaces input or output data with an input/output device. The input/output interface 560 is connected to a display unit 561 and an operation unit 562. The input/output interface 560 may also be connected to a storage medium 564. Furthermore, a loudspeaker 563 serving as a voice output unit, a microphone serving as a voice input unit, or a GPS position determiner may be connected. Note that programs and data that are associated with the general-purpose functions of the information processing apparatus 200 and other feasible functions are not shown in the RAM 540 or the storage 550 of FIG. 5.

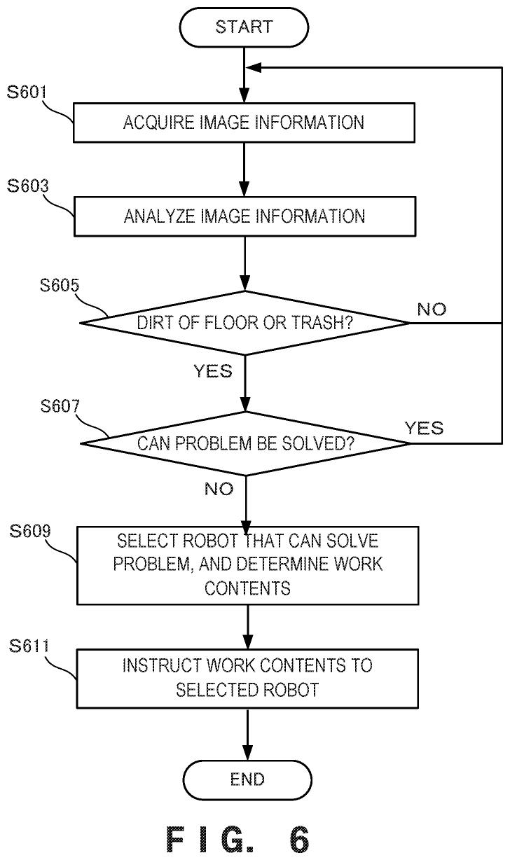

FIG. 6 is a flowchart for explaining the processing procedure of the information processing apparatus 200 according to this example embodiment. This flowchart is executed by the CPU 510 using the RAM 540, thereby implementing the functional components of the information processing apparatus 200 shown in FIG. 3.

In step S601, the information processing apparatus 200 acquires image information. In step S603, the information processing apparatus 200 analyzes the acquired image information. In step S605, the information processing apparatus 200 determines whether the floor is dirty or there is trash. If determining that these problems have not occurred, the information processing apparatus 200 returns to step S601. If determining that these problems have occurred, the information processing apparatus 200 advances to step S607.

In step S607, the information processing apparatus 200 judges whether or the robot that has transmitted the image information can solve the occurred problem. If it is judged that the robot can solve the problem, the information processing apparatus 200 returns to step S601 and leaves processing to the robot. If it is judged that the robot cannot solve the problem, the information processing apparatus 200 advances to step S609.

In step S609, the information processing apparatus 200 determines or selects a robot (cooperative robot) that can solve the occurred problem, and determines work contents to be executed by the selected robot. In step S611, the information processing apparatus 200 instructs the position information of the problem and the work contents of, for example, sweeping the floor or picking up the trash to the selected robot.

According to this example embodiment, even if the floor of a store is dirty or there is trash on the floor, the response to that is automatically processed using a robot. A plurality of robots can cooperate to cope with a problem occurring outside robots. Furthermore, a robot can automatically solve a problem occurring in a store without intervention of an operator. In addition, since it is unnecessary to interpose any operator, it is also possible to reduce the operation cost of a system.

### Third Example Embodiment

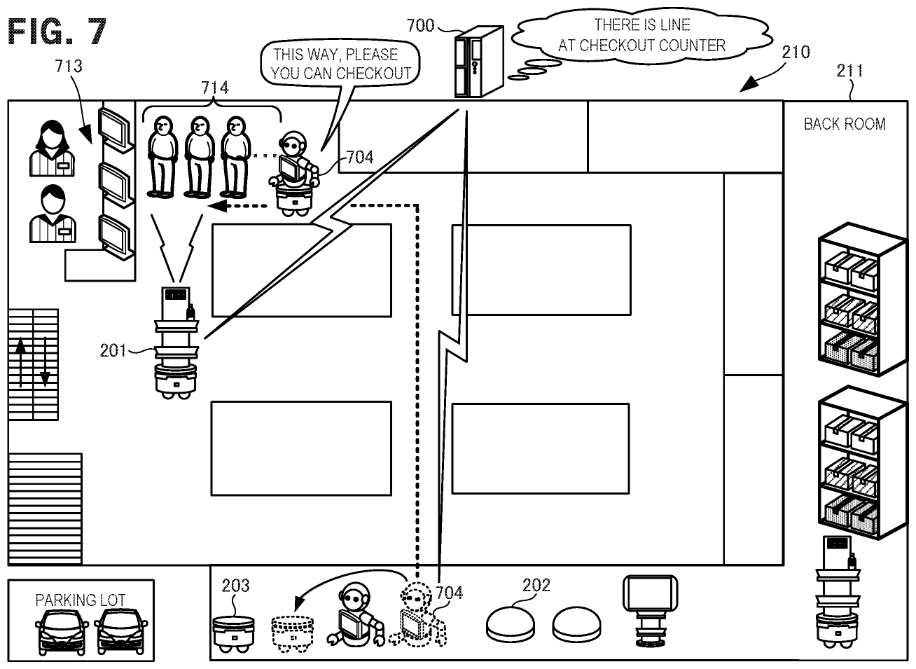

An information processing apparatus according to the third example embodiment of the present invention will be described next with reference to FIGS. 7 to 11. The information processing apparatus according to this example embodiment is different from that according to the above-described second example embodiment in that a queue analyzer is further provided. The remaining components and operations are similar to those in the second example embodiment. Hence, the same reference numerals denote similar components and operations, and a detailed description thereof will be omitted.

FIG. 7 is a view showing an example of processing by an information processing apparatus 700 according to this example embodiment. The information processing apparatus 700 analyzes image information acquired from a conveying robot 201 working in a store 210 to detect a line of waiting customers 714 in front of a register 713. If the number of customers 714 queuing in the line exceeds a predetermined threshold, the information processing apparatus 700 executes the following processing to eliminate the wait for checkout. Note that the wait for checkout may be determined based on the number of shopping baskets or the like, instead of the number of customers 714 queuing at the register 713.

Upon detecting the queue of the waiting customer 714, the information processing apparatus 700 determines that the conveying robot 201 cannot eliminate the line of the waiting customers 714. To eliminate the line of the waiting customers 714, the information processing apparatus 700 selects a checkout robot 704 having a checkout function. The checkout robot 704 having the checkout function is, for example, a card payment-only robot, but may be a robot that copes with card payment and cash payment. Note that the information processing apparatus 700 may cause the checkout robot 704 to issue, to the customer 714 who has checked out using the checkout robot 704, a receipt that proves checkout completion. Thus, since the customer 714 has checked out using the checkout robot 704, even if the customer 714 has not passed through the register 713, he/she can go out of the store 210 after the end of checkout.

The information processing apparatus 700 instructs work contents to the selected checkout robot 704. As the work contents instructed by the information processing apparatus 700, for example, the robot goes to the front of the register 713 and executes a checkout work in or beside the register 713. Alternatively, the instructed work contents may be work contents of executing a checkout work in another place in the store 210. That is, for example, the checkout robot 704 standing by in a back room 211 moves into the store 210 to execute a checkout work. Note that in accordance with the number of waiting customers 714, the information processing apparatus 700 may determine the number of checkout robots 204 to move into the store 210.

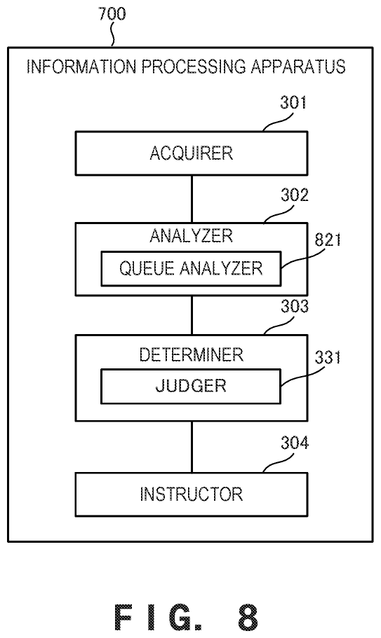

FIG. 8 is a block diagram showing the arrangement of the information processing apparatus 700 according to this example embodiment. The information processing apparatus 700 further includes a queue analyzer 821. If, for example, the number of customers 714 queuing in front of the register 713 exceeds the predetermined threshold, the queue analyzer 821 determines that a line of the customers is formed. For example, even if the number of customers 714 queuing does not exceed the predetermined threshold, but if the number of shopping baskets carried by the customers 714 exceeds the predetermined threshold, it is determined that it will take time to perform checkout processing at the register 713. So it is determined that a line of the customers is formed.

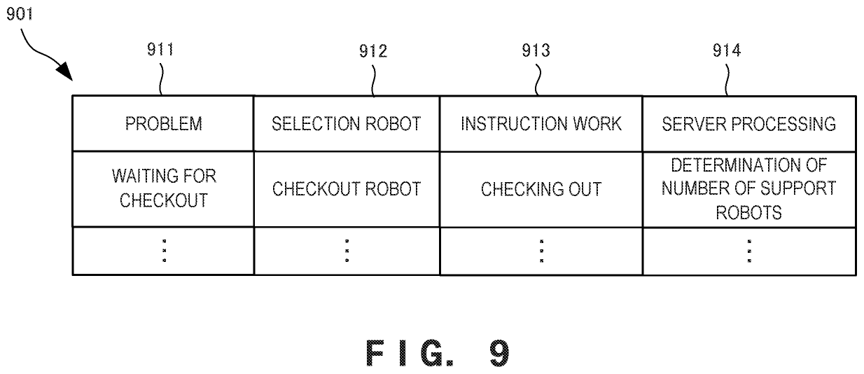

FIG. 9 is a table showing an example of a problem solving table 901 provided in the information processing apparatus 700 according to this example embodiment. The problem solving table 901 stores, in association with a problem 911, a selection robot 912, an instruction work 913, and server processing 914. For example, the information processing apparatus 700 solves a waiting for checkout problem at the register 713 with reference to the problem solving table 901.

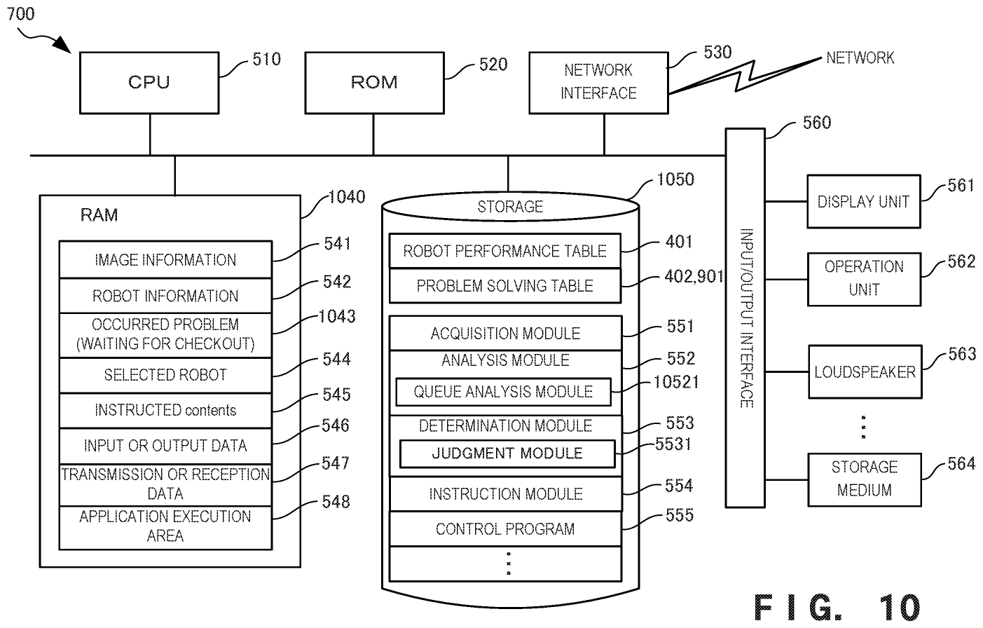

FIG. 10 is a block diagram showing the hardware arrangement of the information processing apparatus 700 according to this example embodiment. A RAM 1040 is a random access memory used as a temporary storage work area by a CPU 510. An area to store data necessary for implementation of the example embodiment is allocated to the RAM 1040. An occurred problem (waiting for checkout wait) 1043 is a problem occurring in the store 210. This data is loaded from, for example, the problem solving table 901.

A storage 1050 stores a database, various parameters, or the following data or programs necessary for implementation of this example embodiment. The storage 1050 further stores the problem solving table 901. The problem solving table 901 is the table, shown in FIG. 9, for managing the relationship among the occurred problem (waiting for checkout wait) 911, the selection robot 912, and the like. The storage 1050 further stores a queue analysis module 10521. The queue analysis module 10521 is a module that analyzes whether a line of the customers 714 is formed in front of the register 713. This queue analysis module 10521 is loaded to an application execution area 548 of the RAM 1040 and executed by the CPU 510. Note that programs and data that are associated with the general-purpose functions of the information processing apparatus 700 and other feasible functions are not shown in the RAM 1040 or the storage 1050 of FIG. 10.

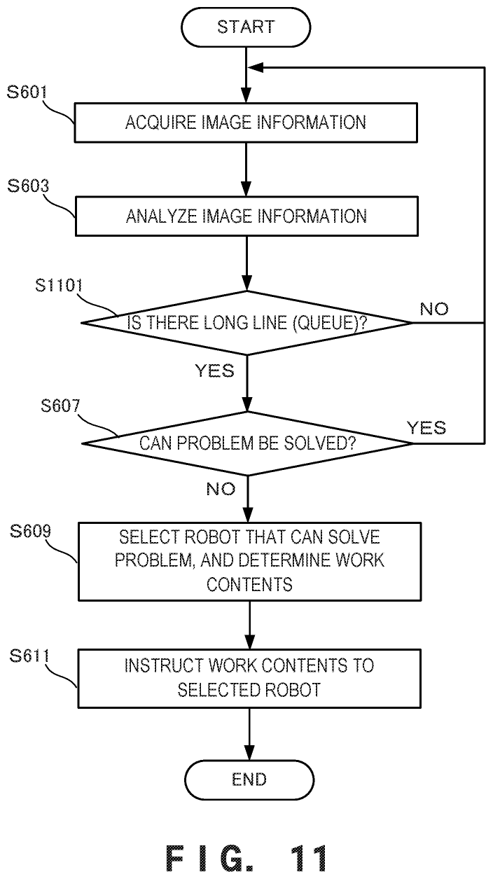

FIG. 11 is a flowchart for explaining the processing procedure of the information processing apparatus 700 according to this example embodiment. This flowchart is executed by the CPU 510 using the RAM 1040, thereby implementing the functional components of the information processing apparatus 700 shown in FIG. 8. In step S1101, the information processing apparatus 700 determines whether a long line of the customers 714 is formed in front of the register 713. The long line determination processing is performed by, for example, comparing the number of waiting people, the number of shopping baskets, or the like with the predetermined threshold. If no line is formed, the information processing apparatus 700 returns to step S601. If a line is formed, the information processing apparatus 700 advances to the next step S607.

According to this example embodiment, if a line of waiting customers is formed in front of a register, the line of waiting customers can automatically be eliminated using a robot. A plurality of robots can cooperate to cope with a problem occurring outside robots. Furthermore, a robot can automatically solve a problem occurring in a store without intervention of an operator. In addition, since it is unnecessary to interpose any operator, it is also possible to reduce the operation cost of a system.

### Fourth Example Embodiment

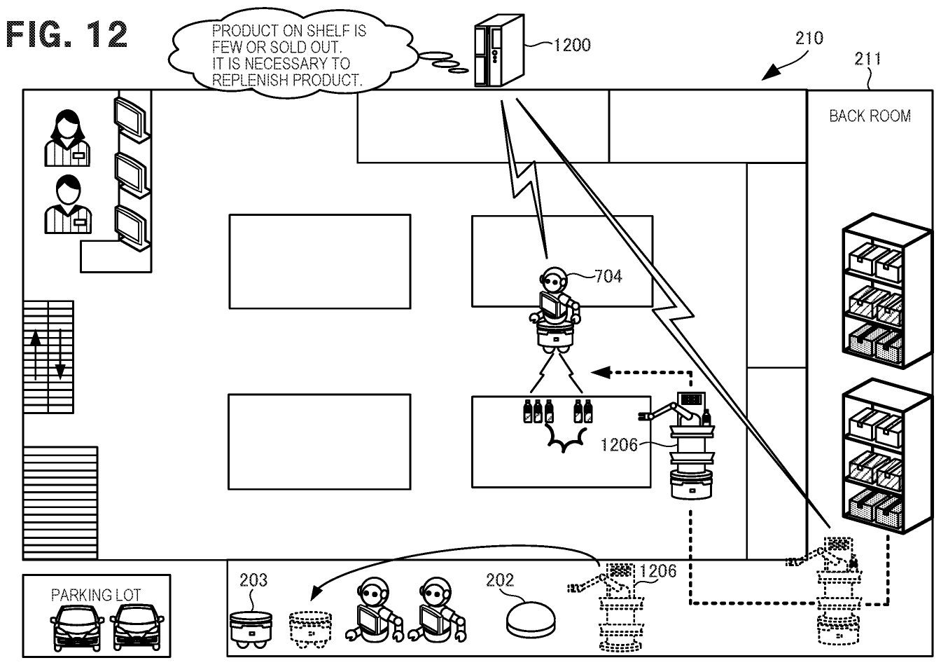

An information processing apparatus according to the fourth example embodiment of the present invention will be described next with reference to FIGS. 12 to 16. The information processing apparatus according to this example embodiment is different from those according to the above-described second and third example embodiments in that a product shortage analyzer is further provided. The remaining components and operations are similar to those in the second and third example embodiments. Hence, the same reference numerals denote similar components and operations, and a detailed description thereof will be omitted.

FIG. 12 is a view showing an example of processing by an information processing apparatus 1200 according to this example embodiment. The information processing apparatus 1200 analyzes image information acquired from a checkout robot 704 moving in a store 210 to detect a product shortage from the display state of a store shelf. A product shortage is detected by, for example, comparing past image information of the store shelf with current image information of the store shelf. That is, a product shortage is detected by, for example, comparing a past display state of the store shelf with a current display state of the store shelf. Furthermore, if a product shortage is detected, the information processing apparatus 1200 analyzes a product in which shortage has occurred, and determines whether or not the short product exists in a back room 211. Note that if, for example, there is no stock of the short product in the back room 211, the information processing apparatus 1200 may perform order processing of the product.

Upon detecting shortage of a product, the information processing apparatus 1200 determines that the checkout robot 704 cannot replenish the short product. To replenish the short product, the information processing apparatus 1200 selects a product replenishing robot 1206 having a replenishing function of replenishing a product. Note that a plurality of product replenishing robots 1206 may be selected.

The information processing apparatus 1200 instructs work contents to the selected product replenishing robot 1206. As the work contents instructed by the information processing apparatus 1200, for example, the robot takes out the short product from the back room 211 and replenishes the took out product on the store shelf. That is, the product replenishing robot 1206 standing by in the back room 211 carries out, from the back room 211, the product to be replenished, thereby executing the replenishing work of the short product.

Note that even if a customer takes out a product from a store shelf, and puts the product in a shopping basket or a shopping basket of a cart robot, the information processing apparatus 1200 performs processing similar to the above-described processing.

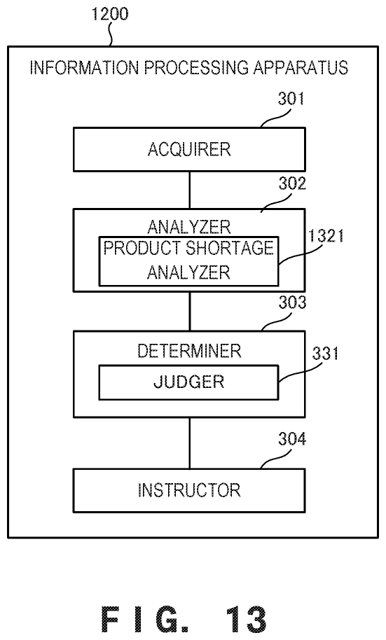

FIG. 13 is a block diagram showing the arrangement of the information processing apparatus 1200 according to this example embodiment. The information processing apparatus 1200 further includes a product shortage analyzer 1321. The product shortage analyzer 1321 analyzes, from the acquired image information, whether or not there is a short product on the store shelf. Furthermore, the product shortage analyzer 1321 analyzes a product in which shortage has occurred and whether or not there is stock of the short product in the back room 211.

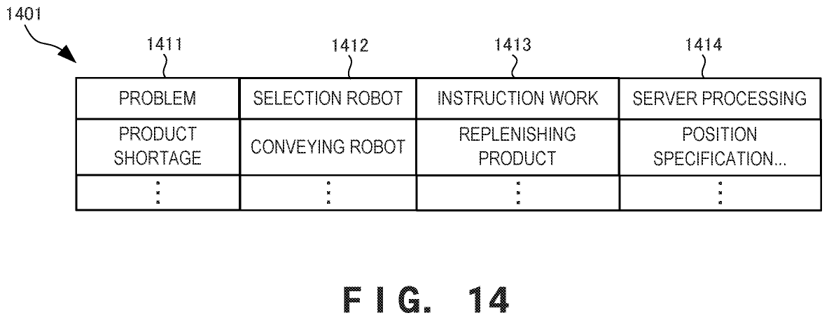

FIG. 14 is a table showing an example of a problem solving table 1401 provided in the information processing apparatus 1200 according to this example embodiment. The problem solving table 1401 stores, in association with a problem 1411, a selection robot 1412, an instruction work 1413, and server processing 1414. For example, the information processing apparatus 1200 causes the product replenishing robot 1206 to execute a replenishing work of a short product with reference to the problem solving table 1401.

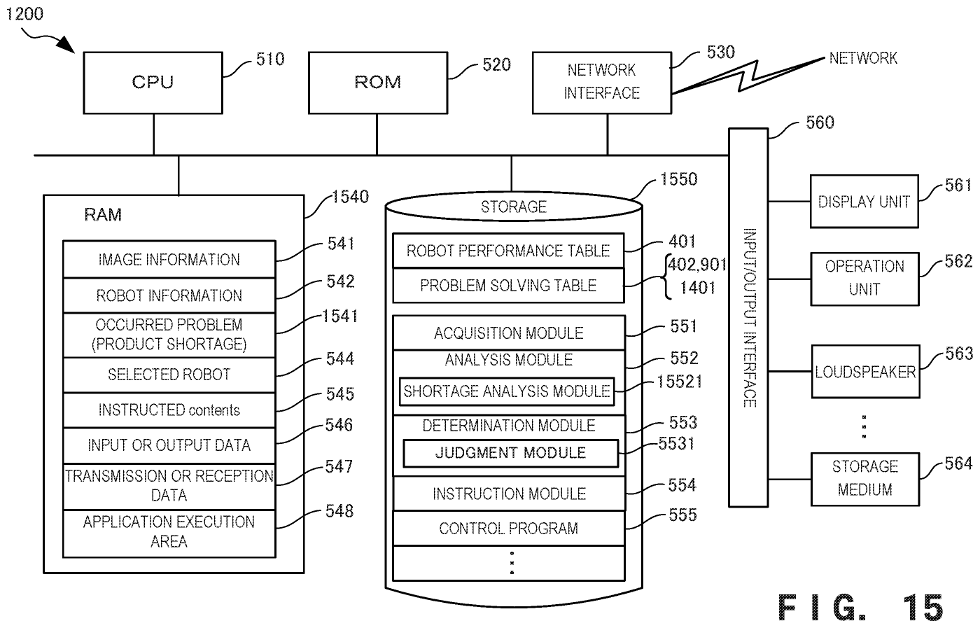

FIG. 15 is a block diagram showing the hardware arrangement of the information processing apparatus 1200 according to this example embodiment. A RAM 1540 is a random access memory used as a temporary storage work area by a CPU 510. An area to store data necessary for implementation of the example embodiment is allocated to the RAM 1540. An occurred problem (product shortage) 1541 is a problem occurring in the store 210. This data is loaded from, for example, the problem solving table 1401.

A storage 1550 stores a database, various parameters, or the following data or programs necessary for implementation of this example embodiment. The storage 1550 further stores the problem solving table 1401. The problem solving table 1401 is the table, shown in FIG. 14, for managing the relationship among the occurred problem (product shortage) 1411, the selection robot 1412, and the like. The storage 1550 further stores a shortage analysis module 15521. The shortage analysis module 15521 is a module that analyzes a product in which shortage has occurred and whether or not there is stock of the short product in the back room 211. This module 15521 is loaded to an application execution area 548 of the RAM 1540 and executed by the CPU 510. Note that programs and data that are associated with the general-purpose functions of the information processing apparatus 1200 and other feasible functions are not shown in the RAM 1540 or the storage 1550 of FIG. 15.

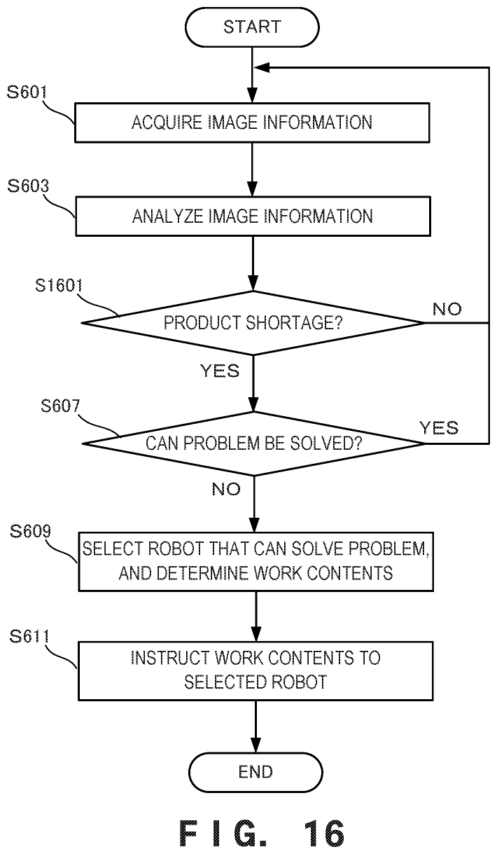

FIG. 16 is a flowchart for explaining the processing procedure of the information processing apparatus 1200 according to this example embodiment. This flowchart is executed by the CPU 510 using the RAM 1540, thereby implementing the functional components of the information processing apparatus 1200 shown in FIG. 13. In step S1601, the information processing apparatus 1200 determines, from the acquired image information, whether or not there is a short product. Whether there is a short product is analyzed by, for example, comparing the past image information (past display state) of the store shelf with the current image information (current display state) of the store shelf. If there is no short product, the information processing apparatus 1200 returns to step S601. If there is a short product, the information processing apparatus 1200 analyzes, for example, whether or not there is stock of the short product in the back room 211.

According to this example embodiment, if shortage occurs in a product, it is possible to automatically replenish the short product. A plurality of robots can cooperate to cope with a problem occurring outside robots. Furthermore, a robot can automatically solve a problem occurring in a store without intervention of an operator. In addition, since it is unnecessary to interpose any operator, it is also possible to reduce the operation cost of a system.

### Fifth Example Embodiment

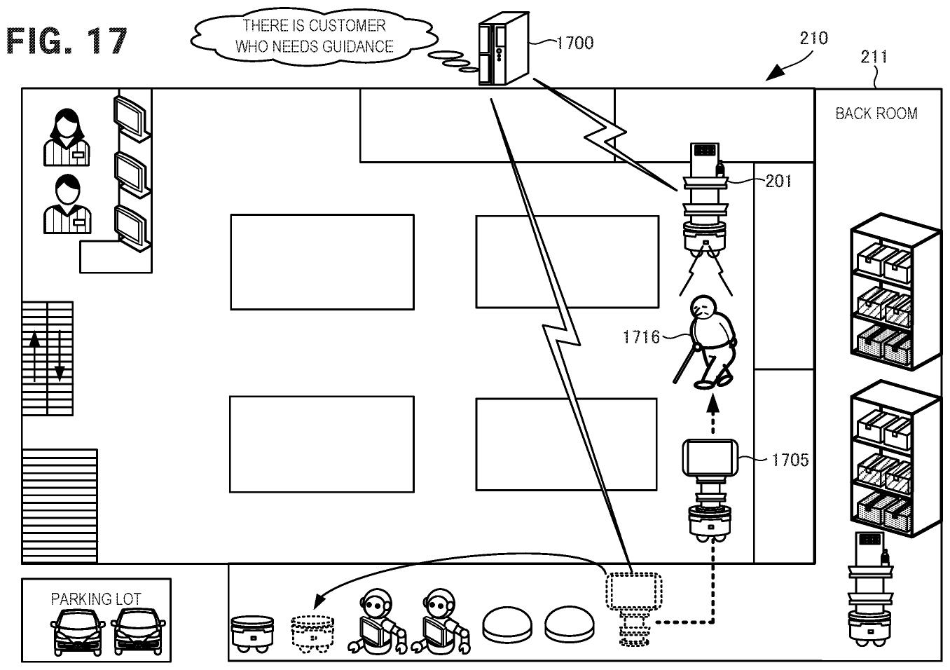

An information processing apparatus according to the fifth example embodiment of the present invention will be described next with reference to FIGS. 17 to 21. The information processing apparatus according to this example embodiment is different from those according to the above-described second to fourth example embodiments in that a customer analyzer is further provided. The remaining components and operations are similar to those in the second to fourth example embodiments. Hence, the same reference numerals denote similar components and operations, and a detailed description thereof will be omitted.

FIG. 17 is a view showing an example of processing by an information processing apparatus 1700 according to this example embodiment. The information processing apparatus 1700 analyzes image information acquired from a conveying robot 201 moving in a store 210 to detect a customer 1716 who needs a customer service. Upon detecting the customer 1716, the information processing apparatus 1700 analyzes an age, sex, language, and the like of the customer 1716.

In addition, upon detecting the customer 1716 who needs a customer service, the information processing apparatus 1700 determines that the conveying robot 201 cannot perform a customer service for the customer 1716. To perform a customer service for the customer 1716, the information processing apparatus 1700 selects a customer guide robot 1705 as a robot having a customer guidance function of guiding a customer. The information processing apparatus 1700 selects the customer guide robot 1705 based on the age, sex, language, and the like of the customer 1716. Note that a plurality of customer guide robots 1705 may be selected.

The information processing apparatus 1700 instructs work contents to the selected customer guide robot 1705. As the work contents instructed by the information processing apparatus 1700, for example, the robot goes to the customer 216 to listen to the request of the customer 1716. That is, the customer guide robot 205 standing by in a back room 211 moves from the back room 211 to a place where there is the customer 216, and listens to the request of the customer 216 and guides him/her. Furthermore, if the customer 216 needs assistance, the robot may call an employee in charge of assistance or guide the customer to a lounge or the like.

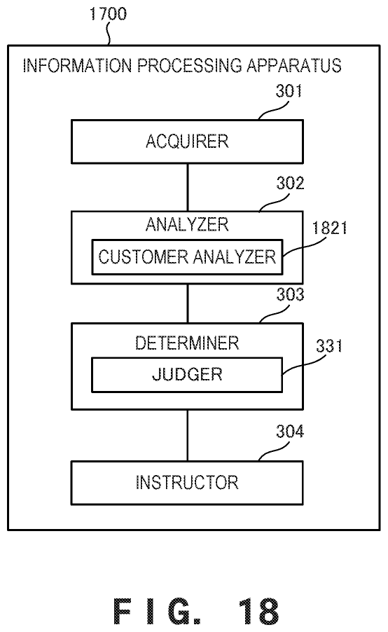

FIG. 18 is a block diagram showing the arrangement of the information processing apparatus 1700 according to this example embodiment. The information processing apparatus 1700 further includes a customer analyzer 1821. The customer analyzer 1821 analyzes the age, sex, language, and the like of the customer 1716 from the acquired image information. Note that when analyzing the language of the customer 1716, the customer analyzer 1821 may acquire voice information of the customer 1716, and analyzes the language based on the acquired voice information.

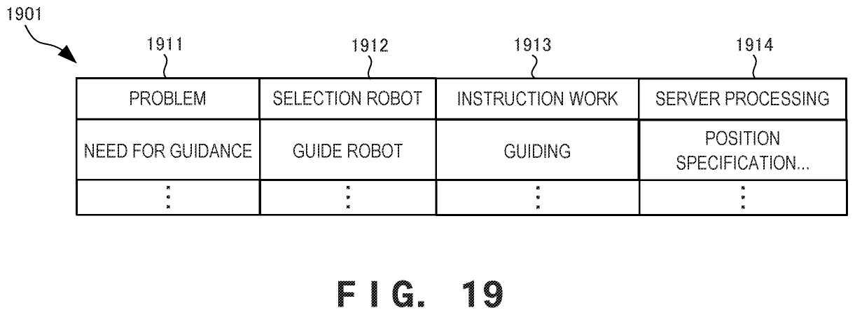

FIG. 19 is a table showing an example of a problem solving table 1901 provided in the information processing apparatus 1700 according to this example embodiment. The problem solving table 1901 stores, in association with a problem 1911, a selection robot 1912, an instruction work 1913, and server processing 1914. For example, the information processing apparatus 1700 causes the customer guide robot 1705 to execute a customer guiding work with reference to the problem solving table 1901.

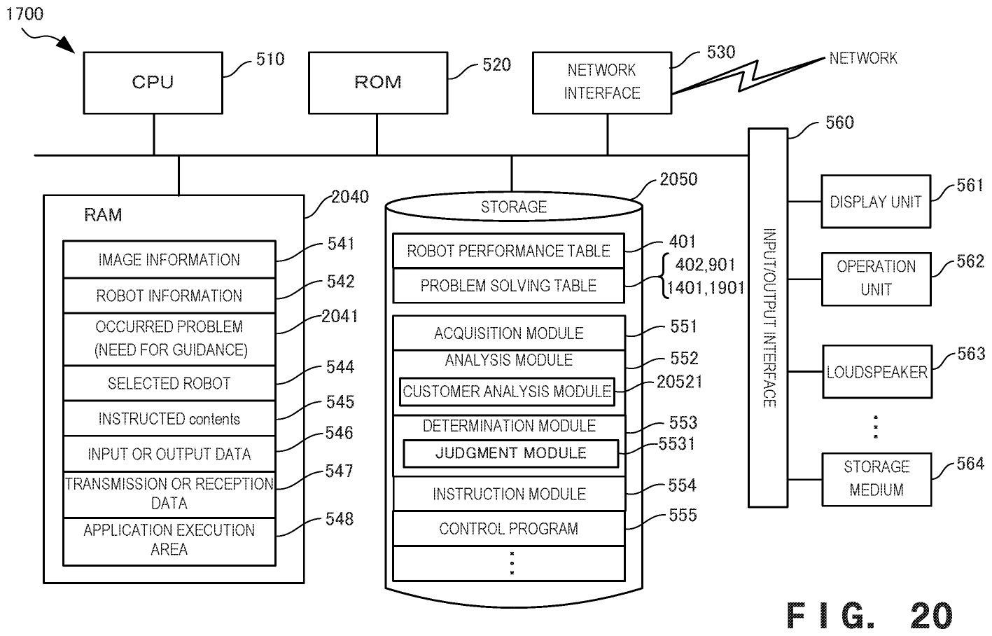

FIG. 20 is a block diagram showing the hardware arrangement of the information processing apparatus 1700 according to this example embodiment. A RAM 2040 is a random access memory used as a temporary storage work area by a CPU 510. An area to store data necessary for implementation of the example embodiment is allocated to the RAM 2040. An occurred problem (need for guidance) 2041 is a problem occurring in the store 210. This data is loaded from, for example, the problem solving table 1901.

A storage 2050 stores a database, various parameters, or the following data or programs necessary for implementation of this example embodiment. The storage 2050 further stores the problem solving table 1901. The problem solving table 1901 is the table, shown in FIG. 19, for managing the relationship among the occurred problem (need for guidance) 1911, the selection robot 1912, and the like. The storage 2050 further stores a customer analysis module 20521. The customer analysis module 20521 is a module that analyzes the age, sex, language, and the like of the customer 1716. This module 20521 is loaded to an application execution area 548 of the RAM 2040 and executed by the CPU 510. Note that programs and data that are associated with the general-purpose functions of the information processing apparatus 1700 and other feasible functions are not shown in the RAM 2040 or the storage 2050 of FIG. 20.

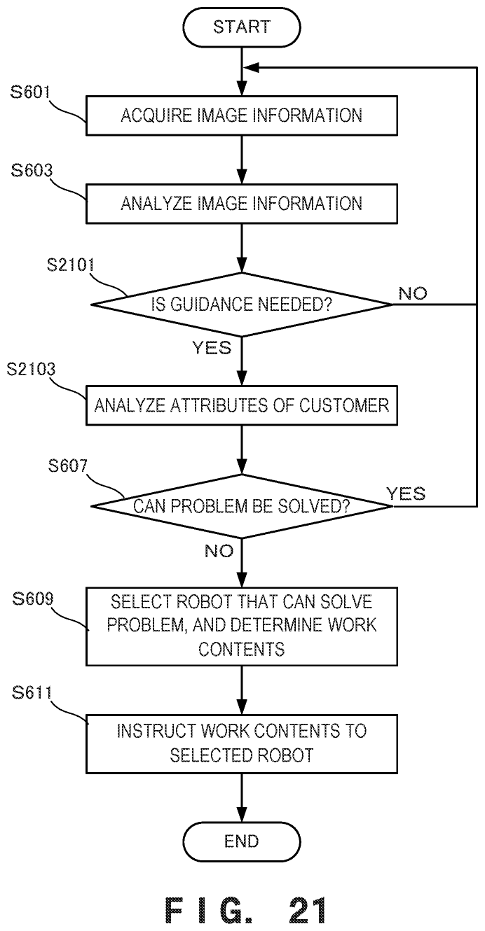

FIG. 21 is a flowchart for explaining the processing procedure of the information processing apparatus 1700 according to this example embodiment. This flowchart is executed by the CPU 510 using the RAM 2040, thereby implementing the functional components of the information processing apparatus 1700 shown in FIG. 18. In step S2101, the information processing apparatus 1700 determines, from the acquired image information, whether there is the customer 1716 who needs a guidance. If there is no customer 1716 who needs a guidance, the information processing apparatus 1700 returns to step S601. If there is a customer 1716 who needs a guidance, the information processing apparatus 1700 advances to the next step. In step S2103, the information processing apparatus 1700 analyzes attributes of the customer 1716 such as the age, sex, and language.

According to this example embodiment, if there is a customer who needs a guidance, it is possible to automatically guide the customer who needs the guidance. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### Sixth Example Embodiment

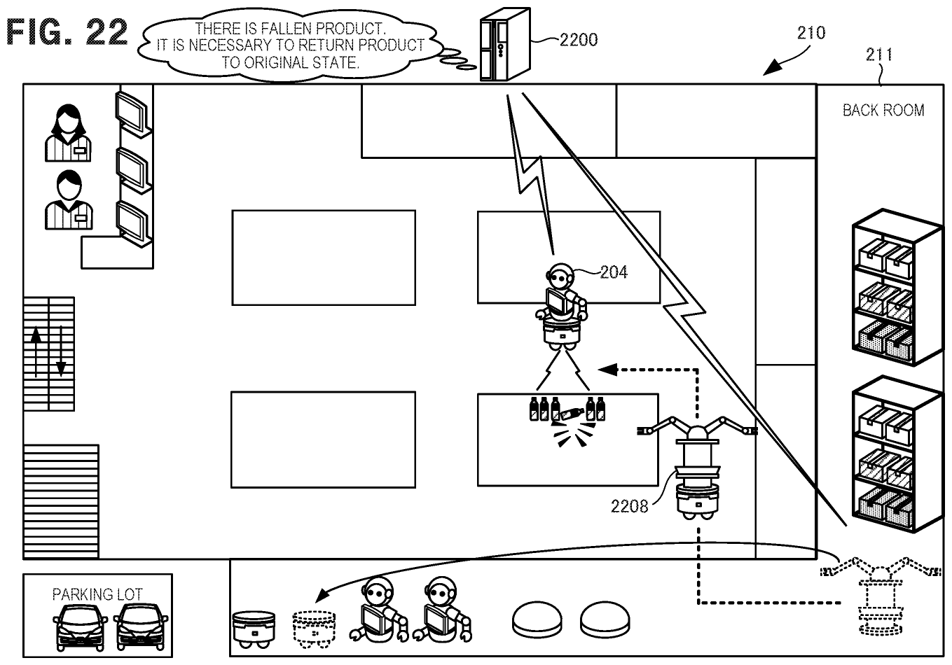

An information processing apparatus according to the sixth example embodiment of the present invention will be described next with reference to FIGS. 22 to 26. The information processing apparatus according to this example embodiment is different from those according to the above-described second to fifth example embodiments in that a display state analyzer is further provided. The remaining components and operations are similar to those in the second to fifth example embodiments. Hence, the same reference numerals denote similar components and operations, and a detailed description thereof will be omitted.

FIG. 22 is a view showing an example of processing by an information processing apparatus 2200 according to this example embodiment. The information processing apparatus 2200 analyzes image information acquired from a checkout robot 204 moving in a store 210 to detect a fallen product from the display state of a store shelf. Upon detecting a fallen product, the information processing apparatus 2200 determines that the checkout robot 204 cannot return the fallen product to the original state. To return the fallen product to the original state, the information processing apparatus 2200 selects a tidying robot 2208 having a tidying function of tidying up the disturbed display of the shelf. Note that if, for example, there are a plurality of products which need to be tidied up, a plurality of tidying robots 2208 may be selected. If a different product is placed on a store shelf, the information processing apparatus 2200 instructs the tidying robot 2208 to rearrange the product at a correct state or position. If the fallen product is broken, the information processing apparatus 2200 may instruct a replenishing robot or the like to replenish a new product.

The information processing apparatus 2200 instructs work contents to the selected tidying robot 2208. As the work contents instructed by the information processing apparatus 2200, for example, the robot goes to the front of the store shelf on which the product has fallen down, and returns the fallen product to the original state. That is, the tidying robot 2208 standing by in a back room 211 goes to the place of the store shelf on which the product has fallen down, and executes a work of returning the fallen product to the original state and tidying up the of the store shelf.

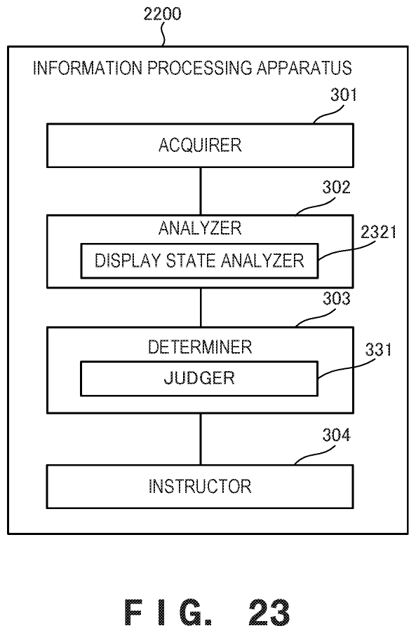

FIG. 23 is a block diagram showing the arrangement of the information processing apparatus 2200 according to this example embodiment. The information processing apparatus 2200 further includes a display status analyzer 2321. The display state analyzer 2321 analyzes the display state of the product display shelf from the acquired image information. The display state analyzer 2321 analyzes the state in which, for example, a displayed product has fallen down, a product for another display shelf is mixed on the display shelf, or a fallen product is broken. The display state is analyzed by, for example, comparing past image information (display state of the display shelf) with current image information (display state of the display shelf).

Then, if a different product is placed on a store shelf, an instructor 304 instructs the tidying robot 2208 to rearrange the product at a correct state or position. Furthermore, if a fallen product is broken, the instructor 304 may instruct a work to a replenishing robot or the like to replenish a new product.

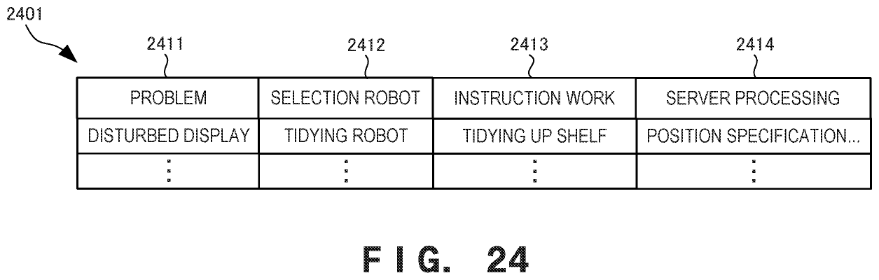

FIG. 24 is a table showing an example of a problem solving table 2401 provided in the information processing apparatus 2200 according to this example embodiment. The problem solving table 2401 stores, in association with a problem (disturbed display) 2411, a selection robot 2412, an instruction work (tidying up shelf) 2413, and server processing 2414. For example, the information processing apparatus 2200 causes the tidying robot 2208 to execute a tidying work with reference to the problem solving table 2401.

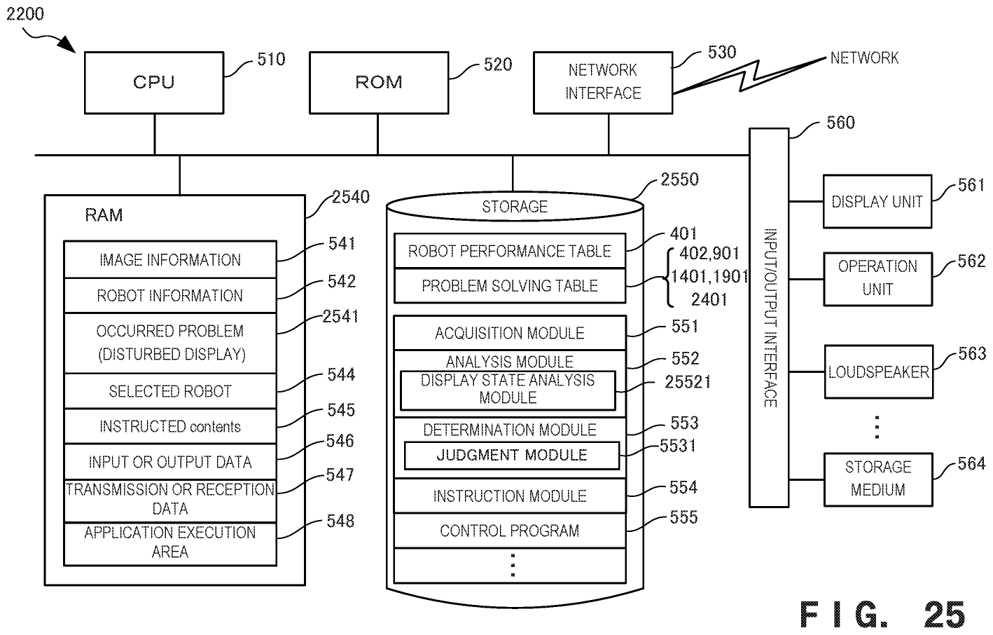

FIG. 25 is a block diagram showing the hardware arrangement of the information processing apparatus 2200 according to this example embodiment. A RAM 2540 is a random access memory used as a temporary storage work area by a CPU 510. An area to store data necessary for implementation of the example embodiment is allocated to the RAM 2540. An occurred problem (disturbed display) 2541 is a problem occurring in the store 210. This data is loaded from, for example, the problem solving table 2401.

A storage 2550 stores a database, various parameters, or the following data or programs necessary for implementation of this example embodiment. The storage 2550 further stores the problem solving table 2401. The problem solving table 2401 is the table, shown in FIG. 24, for managing the relationship among the occurred problem (disturbed display) 2411, the selection robot 2412, and the like. The storage 2550 further stores a display status analysis module 25521. The display state analysis module 25521 is a module that analyzes the display state of products on a display shelf. This module 25521 is loaded to an application execution area 548 of the RAM 2540 and executed by the CPU 510. Note that programs and data that are associated with the general-purpose functions of the information processing apparatus 2200 and other feasible functions are not shown in the RAM 2540 or the storage 2550 of FIG. 25.

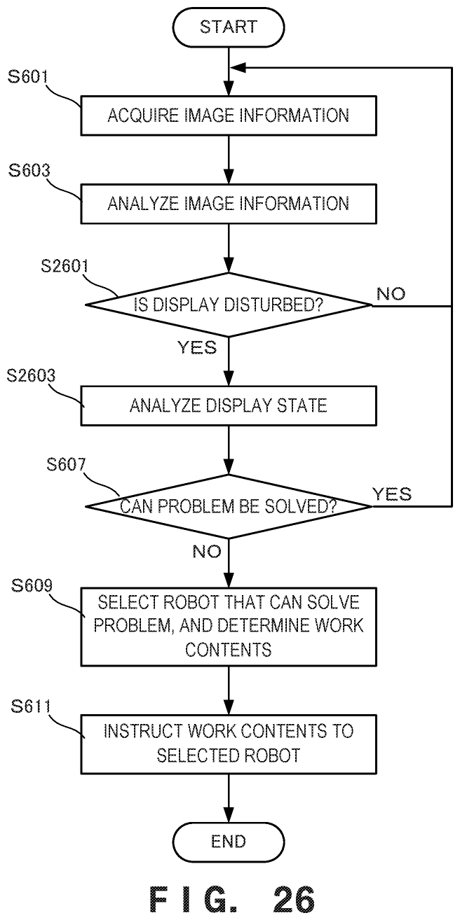

FIG. 26 is a flowchart for explaining the processing procedure of the information processing apparatus 2200 according to this example embodiment. This flowchart is executed by the CPU 510 using the RAM 2540, thereby implementing the functional components of the information processing apparatus 2200 shown in FIG. 23. In step S2601, the information processing apparatus 2200 determines, from the acquired image information, whether or not the display on the product display shelf is disturbed. If the display is not disturbed, the information processing apparatus 2200 returns to step S601. If the display is disturbed, the information processing apparatus 2200 advances to the next step. In step S2603, the information processing apparatus 2200 analyzes the display state. The information processing apparatus 2200 analyzes the display state in which, for example, a displayed product has fallen down, a different or another product is displayed on the display shelf, or a fallen product is broken.

According to this example embodiment, if there is the state in which the display on the shelf is disturbed, it is possible to automatically tidy up the disturbed shelf. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### Seventh Example Embodiment

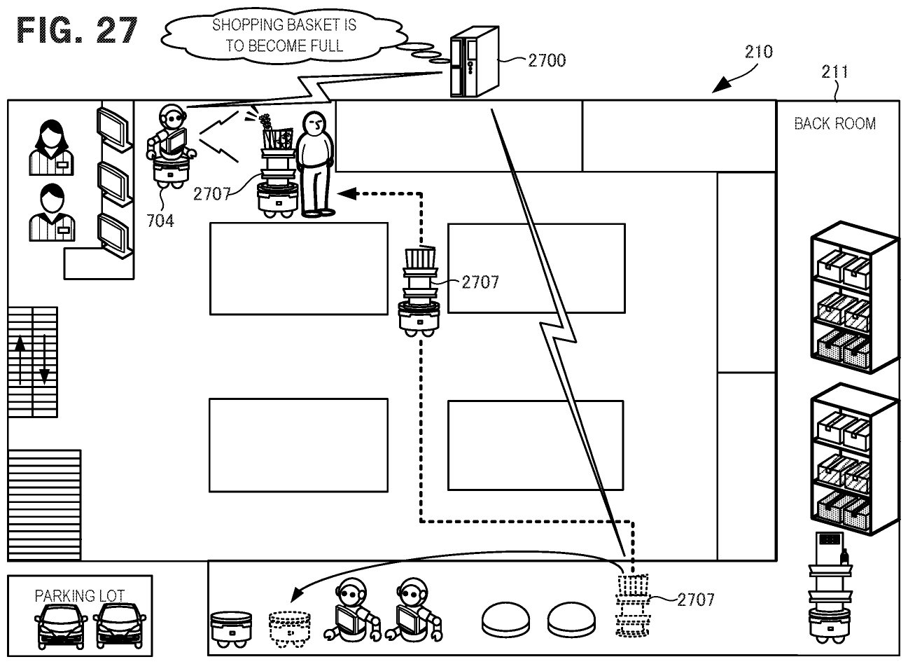

An information processing apparatus according to the seventh example embodiment of the present invention will be described next with reference to FIGS. 27 to 31. The information processing apparatus according to this example embodiment is different from those according to the above-described second to sixth example embodiments in that a customer behavior analyzer is further provided. The remaining components and operations are similar to those in the second to sixth example embodiments. Hence, the same reference numerals denote similar components and operations, and a detailed description thereof will be omitted.

FIG. 27 is a view showing an example of processing by an information processing apparatus 2700 according to this example embodiment. The information processing apparatus 2700 analyzes image information acquired from a checkout robot 704 moving in a store 210, and analyzes a transportation status from an image of a shopping basket of a transportation robot 2707 (or a cart robot), thereby detecting that the shopping basket is to become full. In this case, the information processing apparatus 2700 analyzes the behavior of a customer, for example, whether or not the customer is to continue shopping or to stop shopping and pay for products at a register. If, as a result of the analysis processing, the customer is to continue shopping, the information processing apparatus 2700 executes the following processing. Alternatively, if, as a result of the analysis processing, the customer is to stop shopping, the information processing apparatus 2700 may suspend the processing.

If, for example, the transportation amount such as the number of products or the product weight in the shopping basket of the transportation robot 2707 exceeds a predetermined threshold, the information processing apparatus 2700 judges that the shopping basket is to become full. Upon judging that the shopping basket is to become full, the information processing apparatus 2700 determines that the present transportation robot 2707 cannot transport the products to be purchased. To transport the products to be purchased, the information processing apparatus 2700 selects another transportation robot 2707 having a product transportation function in the back room 211. Note that a plurality of transportation robots 2707 may be selected.

The information processing apparatus 2700 instructs work contents to the selected transportation robot 2707. As the work contents instructed by the information processing apparatus 2700, for example, the robot carries an empty shopping basket to a place where there is the customer with the shopping basket which is to become full. That is, the transportation robot 2707 standing by in a back room 211 moves to the place where there is the customer in the store 210, and executes a work of transporting the products to be purchased by the customer for the customer during shopping in the store 210.

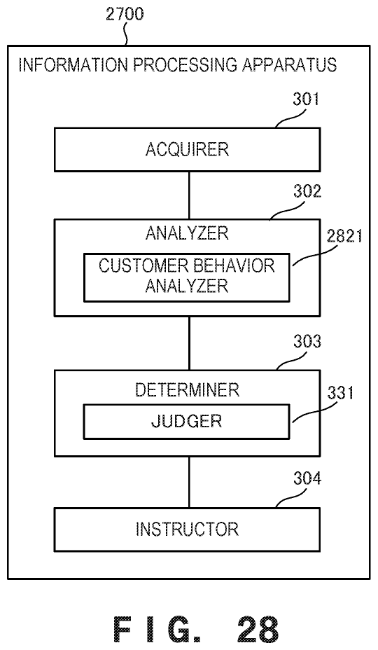

FIG. 28 is a block diagram showing the arrangement of the information processing apparatus 2700 according to this example embodiment. The information processing apparatus 2700 further includes a customer behavior analyzer 2821. The customer behavior analyzer 2821 analyzes the behavior of a customer from the acquired image information. That is, the customer behavior analyzer 2821 analyzes whether the customer is to continue shopping or to stop shopping and pay for products. If, for example, the customer is to go away from a register, the customer behavior analyzer 2821 analyzes that the customer is to continue shopping. If the customer is moving toward the register, the customer behavior analyzer 2821 analyzes that the customer is to pay for the products. Furthermore, the customer behavior analyzer 2821 also analyzes the position of the customer.

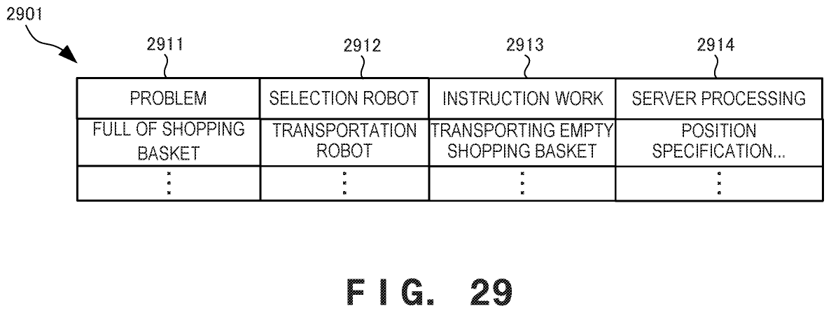

FIG. 29 is a table showing an example of a problem solving table 2901 provided in the information processing apparatus 2700 according to this example embodiment. The problem solving table 2901 stores, in association with a problem (full of shopping basket) 2911, a selection robot 2912, an instruction work (transporting empty shopping basket) 2913, and server processing 2914. For example, the information processing apparatus 2700 causes the transportation robot to execute a transportation work with reference to the problem solving table 2901.

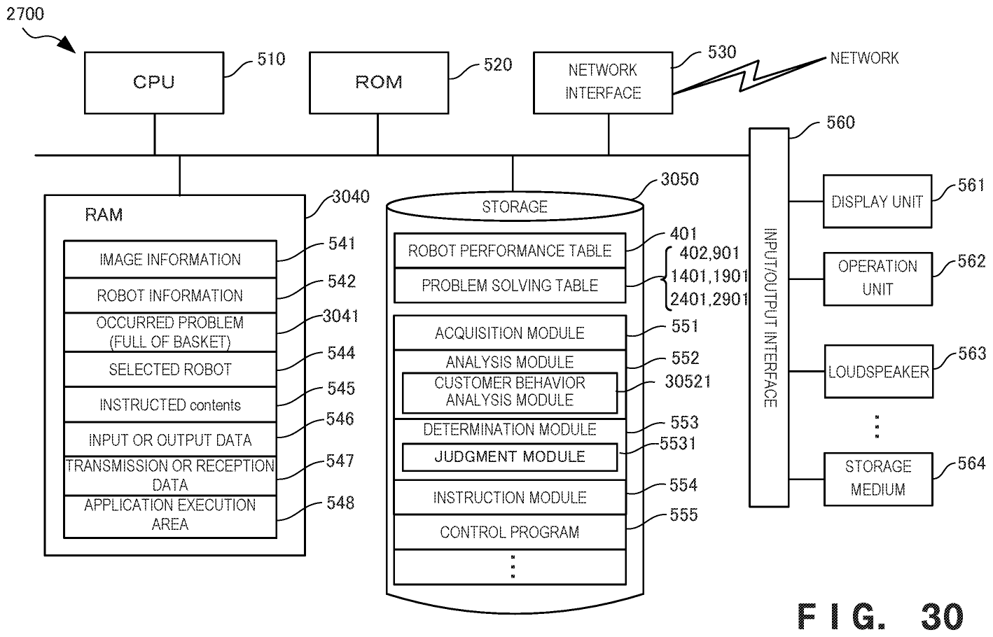

FIG. 30 is a block diagram showing the hardware arrangement of the information processing apparatus 2700 according to this example embodiment. A RAM 3040 is a random access memory used as a temporary storage work area by a CPU 510. An area to store data necessary for implementation of the example embodiment is allocated to the RAM 3040. An occurred problem (full of shopping basket) 3041 is a problem occurring in the store 210. This data is loaded from, for example, the problem solving table 2901.

A storage 3050 stores a database, various parameters, or the following data or programs necessary for implementation of this example embodiment. The storage 3050 further stores the problem solving table 2901. The problem solving table 2901 is the table, shown in FIG. 29, for managing the relationship among the occurred problem (full of shopping basket) 2911, the selection robot 2912, and the like. The storage 3050 further stores a customer behavior analysis module 30521. The customer behavior analysis module 30521 is a module that analyzes whether the customer is to continue shopping or to stop shopping and pay for products. This module 30521 is loaded to an application execution area 548 of the RAM 3040 and executed by the CPU 510. Note that programs and data that are associated with the general-purpose functions of the information processing apparatus 2700 and other feasible functions are not shown in the RAM 3040 or the storage 3050 of FIG. 30.

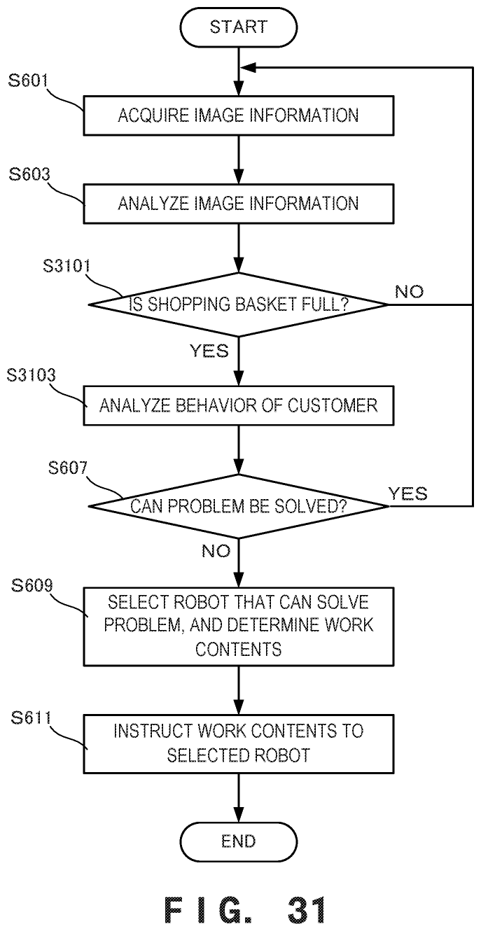

FIG. 31 is a flowchart for explaining the processing procedure of the information processing apparatus 2700 according to this example embodiment. This flowchart is executed by the CPU 510 using the RAM 3040, thereby implementing the functional components of the information processing apparatus 2700 shown in FIG. 28. In step S3101, the information processing apparatus 2700 determines, from the acquired image information, whether or not the shopping basket of the customer is full (or is to become full). If the shopping basket is not full, the information processing apparatus 2700 returns to step S601. If the shopping basket is full, the information processing apparatus 2700 advances to the next step. In step S3103, the information processing apparatus 2700 analyzes the behavior of the customer. That is, the information processing apparatus 2700 analyzes the behavior of the customer whether the customer is to continue shopping or to stop shopping and pay for products at a register. If, for example, the customer is moving away from the register, the information processing apparatus 2700 analyzes that the customer is to continue shopping. Alternatively, if the customer is moving toward the register, the information processing apparatus 2700 analyzes that the customer is to stop shopping and pay for the products. Furthermore, the information processing apparatus 2700 may analyzes the place of the customer.

According to this example embodiment, it is possible to send a transportation robot to provide an empty shopping basket to a customer whose shopping basket is full or is to become full. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### Eighth Example Embodiment

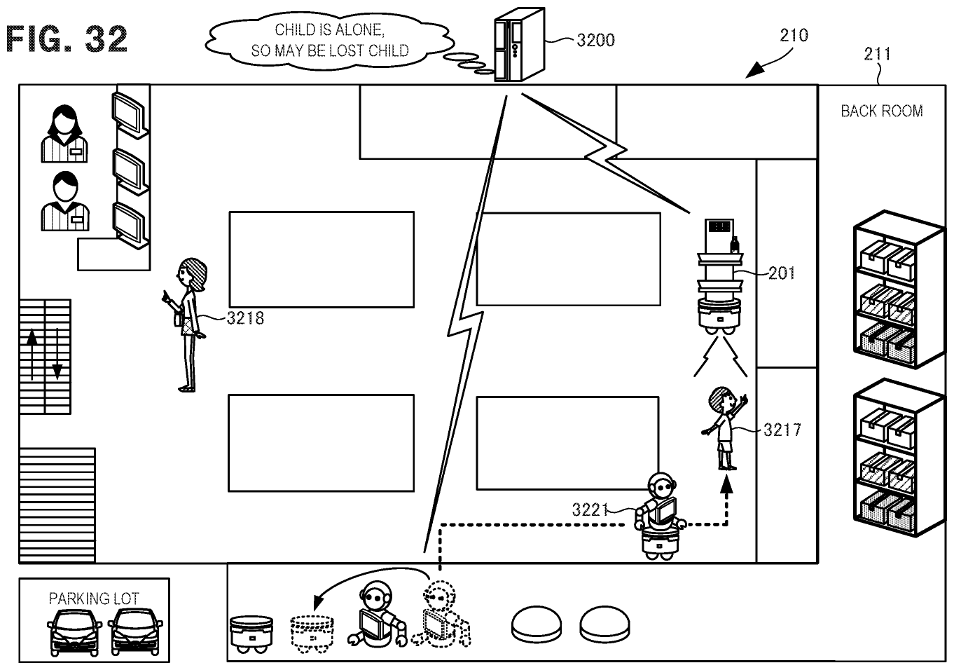

An information processing apparatus according to the eighth example embodiment of the present invention will be described next with reference to FIGS. 32 to 36. The information processing apparatus according to this example embodiment is different from those according to the above-described second to seventh example embodiments in that a lost child analyzer is further provided. The remaining components and operations are similar to those in the second to seventh example embodiments. Hence, the same reference numerals denote similar components and operations, and a detailed description thereof will be omitted.

FIG. 32 is a view showing an example of processing by an information processing apparatus 3200 according to this example embodiment. The information processing apparatus 3200 analyzes image information acquired from a conveying robot 201 moving in a store 210 to detect that a child 3217 is alone in the store 210 without a guardian 3218 nearby. Then, the information processing apparatus 3200 judges that the child 3217 in this state is highly probably a lost child. Note that the information processing apparatus 3200 determines a lost child also based on a time during which the child 3217 is alone, the facial expression (for example, crying or the like) of the child 3217 who is alone, and the like. A lost child determination method is not limited to this.

Upon detecting a lost child, the information processing apparatus 3200 determines that the conveying robot 201 cannot lead the lost child (or deal with the lost child). To lead the lost child, the information processing apparatus 3200 selects a leading robot 3221 having a lost child leading function. Note that a plurality of leading robots 3221 may be selected.

The information processing apparatus 3200 instructs work contents to the selected leading robot 3221. As the work contents instructed by the information processing apparatus 3200, for example, the robot leads the lost child to a lost child center in the store 210 or calls an employee for a lost child to deal with the lost child. That is, the leading robot 3221 standing by in the back room 211 moves to the place of the lost child 3217 in the store 210, and executes a work of leading and protecting the lost child.

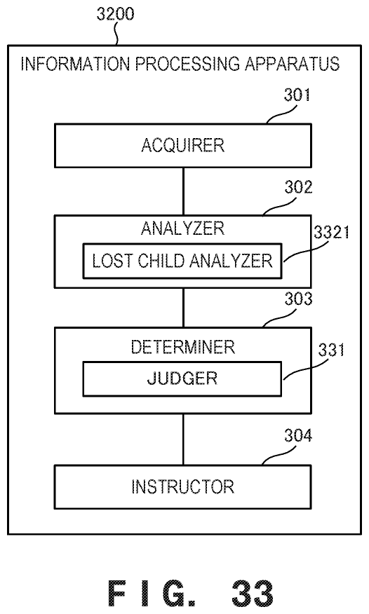

FIG. 33 is a block diagram showing the arrangement of the information processing apparatus 3200 according to this example embodiment. The information processing apparatus 3200 further includes a lost child analyzer 3321. The lost child analyzer 3321 analyzes, from the acquired image information, whether or not the child is a lost child. Based on the time during which the child 3217 is alone, the facial expression of the child 3217, and the like, the lost child analyzer 3321 determines whether or not the child 3217 is a lost child. Furthermore, the lost child analyzer 3321 also analyzes the age, language, and the like of the child 3217 determined as a lost child.

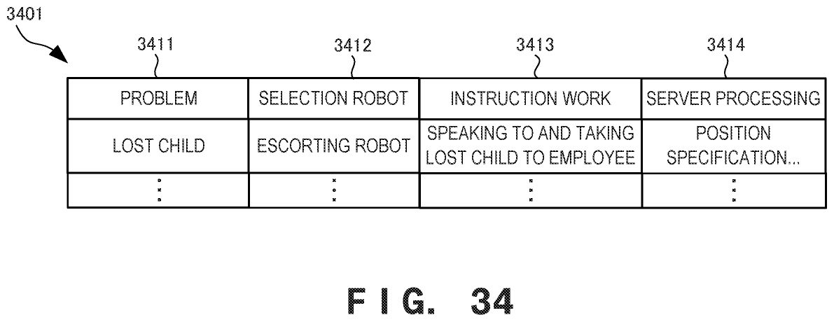

FIG. 34 is a table showing an example of a problem solving table 3401 provided in the information processing apparatus 3200 according to this example embodiment. The problem solving table 3401 stores, in association with a problem 3411, a selection robot 3412, an instruction work 3413, and server processing 3414. For example, the information processing apparatus 3200 causes the leading robot 3221 to execute a lost child leading work with reference to the problem solving table 3401.

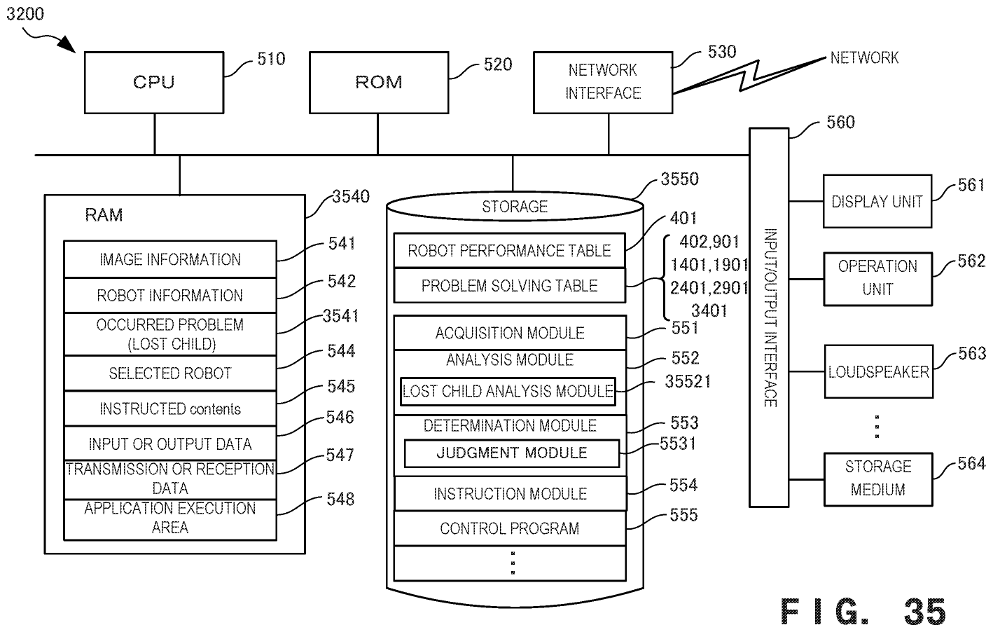

FIG. 35 is a block diagram showing the hardware arrangement of the information processing apparatus 3200 according to this example embodiment. A RAM 3540 is a random access memory used as a temporary storage work area by a CPU 510. An area to store data necessary for implementation of the example embodiment is allocated to the RAM 3540. An occurred problem (lost child) 3541 is a problem occurring in the store 210. This data is loaded from, for example, the problem solving table 3401.

A storage 3550 stores a database, various parameters, or the following data or programs necessary for implementation of this example embodiment. The storage 3550 further stores the problem solving table 3401. The problem solving table 3401 is the table, shown in FIG. 34, for managing the relationship among the occurred problem (lost child) 3411, the selection robot 3412, and the like. The storage 3550 further stores a lost child analysis module 35521. The lost child analysis module 35521 analyzes, based on the time during which the child 3217 is alone, the facial expression of the child 3217, and the like, whether the child 3217 is a lost child. The lost child analysis module 35521 further analyzes the age, language, and the like of the lost child 3217. This module 35521 is loaded to an application execution area 548 of the RAM 3540 and executed by the CPU 510. Note that programs and data that are associated with the general-purpose functions of the information processing apparatus 3200 and other feasible functions are not shown in the RAM 3540 or the storage 3550 of FIG. 35.

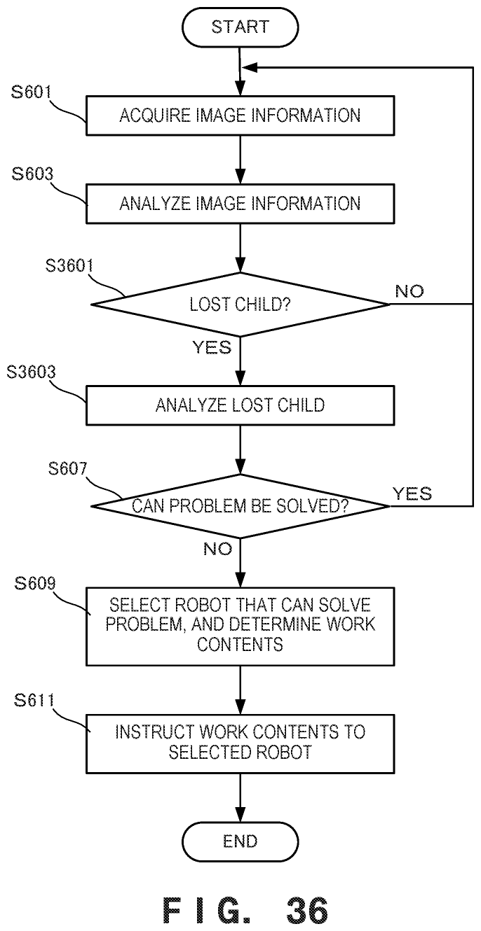

FIG. 36 is a flowchart for explaining the processing procedure of the information processing apparatus 3200 according to this example embodiment. This flowchart is executed by the CPU 510 using the RAM 3540, thereby implementing the functional components of the information processing apparatus 3200 shown in FIG. 32. In step S3601, the information processing apparatus 3200 determines whether or not the child is a lost child. Whether or not the child is a lost child is determined based on, for example, the time during which the child 3217 is alone, the facial expression (for example, crying) of the child 3217, and the like. The present invention, however, is not limited to this. If the child is not a lost child, the information processing apparatus 3200 returns to step S601. If the child is a lost child, the information processing apparatus 3200 advances to the next step. In step S3603, the information processing apparatus 3200 analyzes the lost child. Analysis of the lost child is, for example, analysis of the age, language, and the like of the lost child 3217. If, as described above, the age, language, and the like of the lost child are analyzed, it is possible to appropriately deal with the lost child.

According to this example embodiment, if a lost child is detected, a leading robot moves to the place of the lost child, and it is thus possible to appropriately lead the lost child. In addition, since the leading robot moves to the place of the lost child based on the age, language, and the like of the lost child, it is possible to appropriately lead the lost child. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### Ninth Example Embodiment

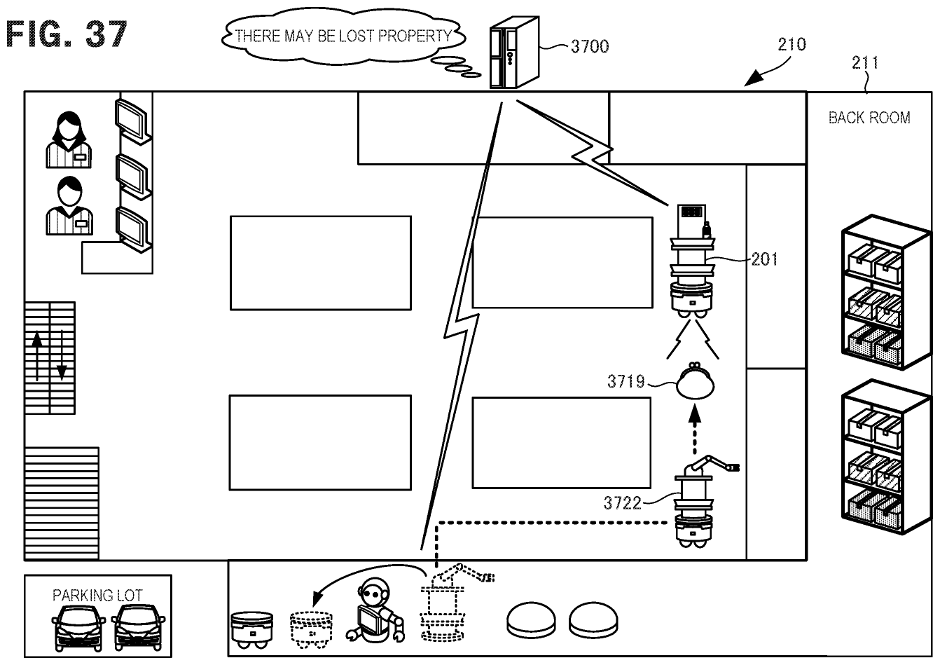

An information processing apparatus according to the ninth example embodiment of the present invention will be described next with reference to FIGS. 37 to 41. The information processing apparatus according to this example embodiment is different from those according to the above-described second to eighth example embodiments in that a lost property analyzer is further provided. The remaining components and operations are similar to those in the second to eighth example embodiments. Hence, the same reference numerals denote similar components and operations, and a detailed description thereof will be omitted.

FIG. 37 is a view showing an example of processing by an information processing apparatus 3700 according to this example embodiment. The information processing apparatus 3700 analyzes image information acquired from a conveying robot 201 moving in a store 210 to detect a lost property 3719 such as a wallet or a smartphone. Upon detecting the lost property 3719, the information processing apparatus 3700 determines that the conveying robot 201 cannot collect the lost property 3719. To collect the lost property 3719, the information processing apparatus 3700 selects a collecting robot 3722 having a collection function of collecting the lost property 3719. Note that a plurality of collecting robots 3722 may be selected in accordance with the number of lost properties 3719 and the like.

The information processing apparatus 3700 instructs work contents to the selected collecting robot 3722. As the work contents instructed by the information processing apparatus 3700, for example, the robot goes to a place where there is the lost property 3719, collects the lost property 3719, and then brings the lost property 3719 to a lost and found department or the like. That is, the collecting robot 3722 standing by in the back room 211 moves to the place where there is the lost property 3719 in the store 210, and executes a work of collecting the lost property 3719 and appropriately processing the collected lost property 3719. Note that if the lost property 3719 is, for example, a product which is sold in the store 210, the product may be returned to the original position.

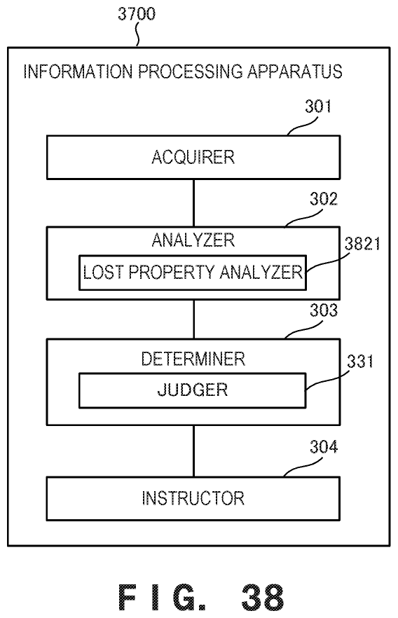

FIG. 38 is a block diagram showing the arrangement of the information processing apparatus 3700 according to this example embodiment. The information processing apparatus 3700 further includes a lost property analyzer 3821. The lost property analyzer 3821 analyzes, from the acquired image information, whether an object is the lost property 3719. The lost property analyzer 3821 detects, for example, an object on the floor by comparing past image information with current image information. Then, based on, for example, the shape, size, color, and the like of the object on the floor, the lost property analyzer 3821 determines whether or not the object is the lost property 3719. The lost property analyzer 3821 analyzes what is the lost property. The lost property is, for example, a wallet or a smartphone.

Furthermore, the lost property analyzer 3821 may analyze the lost property by determining whether the object on the floor is a product which is sold in the store 210. That is, if the object on the floor is a product which is sold in the store 210, the lost property analyzer 3821 does not determine the object as the lost property 3719. On the other hand, if the object is a product which is not sold in the store 210, the lost property analyzer 3821 determines the object on the floor as the lost property 3719. In addition, for example, the lost property analyzer 3821 may specify what the object is by performing an image search by an image of the object on the floor, and then determine whether the object is the lost property 3719.

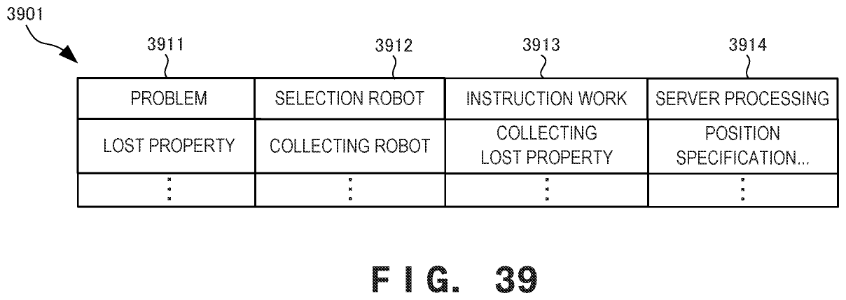

FIG. 39 is a table showing an example of a problem solving table 3901 provided in the information processing apparatus 3700 according to this example embodiment. The problem solving table 3901 stores, in association with a problem (lost property) 3911, a selection robot 3912, an instruction work (collecting lost property) 3913, and server processing 3914. For example, the information processing apparatus 3700 causes the collecting robot to execute a lost property collection work with reference to the problem solving table 3901.

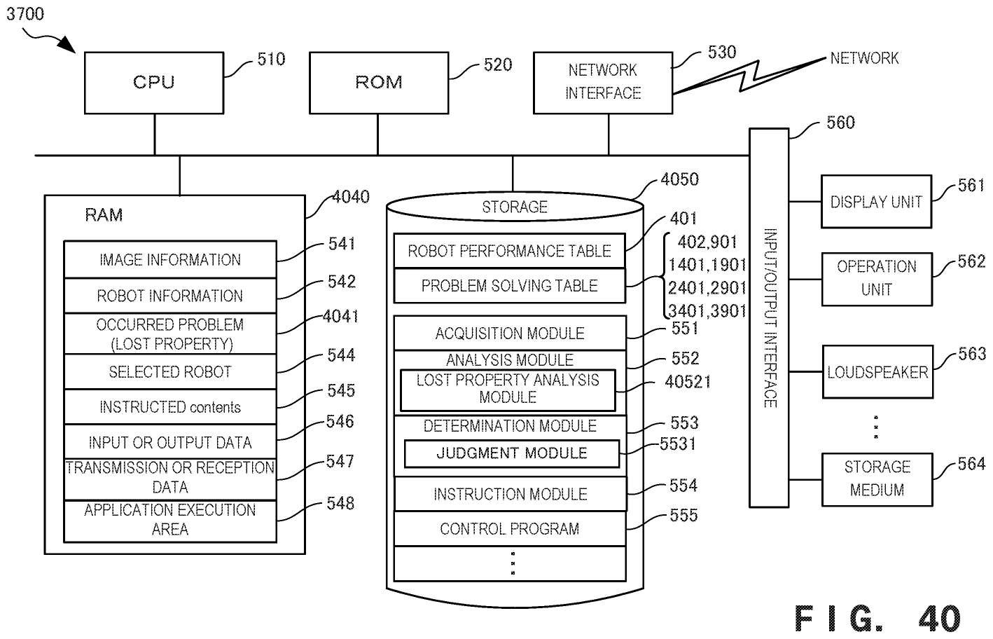

FIG. 40 is a block diagram showing the hardware arrangement of the information processing apparatus 3700 according to this example embodiment. A RAM 4040 is a random access memory used as a temporary storage work area by a CPU 510. An area to store data necessary for implementation of the example embodiment is allocated to the RAM 4040. An occurred problem (lost property) 4041 is a problem occurring in the store 210. This data is loaded from, for example, the problem solving table 3901.

A storage 4050 stores a database, various parameters, or the following data or programs necessary for implementation of this example embodiment. The storage 4050 further stores the problem solving table 3901. The problem solving table 3901 is the table, shown in FIG. 39, for managing the relationship among the occurred problem (lost property) 3911, the selection robot 3912, and the like. The storage 4050 further stores a lost property analysis module 40521. The lost property analysis module 40521 is a module that analyzes whether an object on the floor is a lost property. This module 40521 is loaded to an application execution area 548 of the RAM 4040 and executed by the CPU 510. Note that programs and data that are associated with the general-purpose functions of the information processing apparatus 3700 and other feasible functions are not shown in the RAM 4040 or the storage 4050 of FIG. 40.

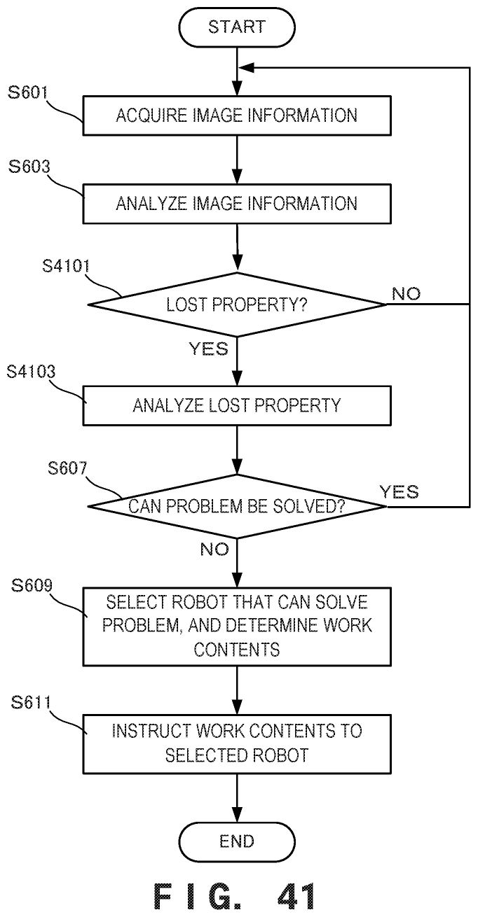

FIG. 41 is a flowchart for explaining the processing procedure of the information processing apparatus 3700 according to this example embodiment. This flowchart is executed by the CPU 510 using the RAM 4040, thereby implementing the functional components of the information processing apparatus 3700 shown in FIG. 37. In step S4101, the information processing apparatus 3700 determines whether an object on the floor is a lost property. Whether an object is a lost property is determined based on, for example, the size, shape, color, and the like of the object on the floor. Furthermore, based on whether the object on the floor is a product sold in the store 210, the information processing apparatus 3700 may determine whether the object is a lost property. If the object is not a lost property, the information processing apparatus 3700 returns to step S601. If the object is a lost property, the information processing apparatus 3700 advances to the next step. In step S4103, the information processing apparatus 3700 may analyze what is the lost property 3719 by performing an image search for the lost property 3719 on the floor.

According to this example embodiment, even if there is a lost property in a store, a collecting robot can automatically collect the lost property. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### 10th Example Embodiment

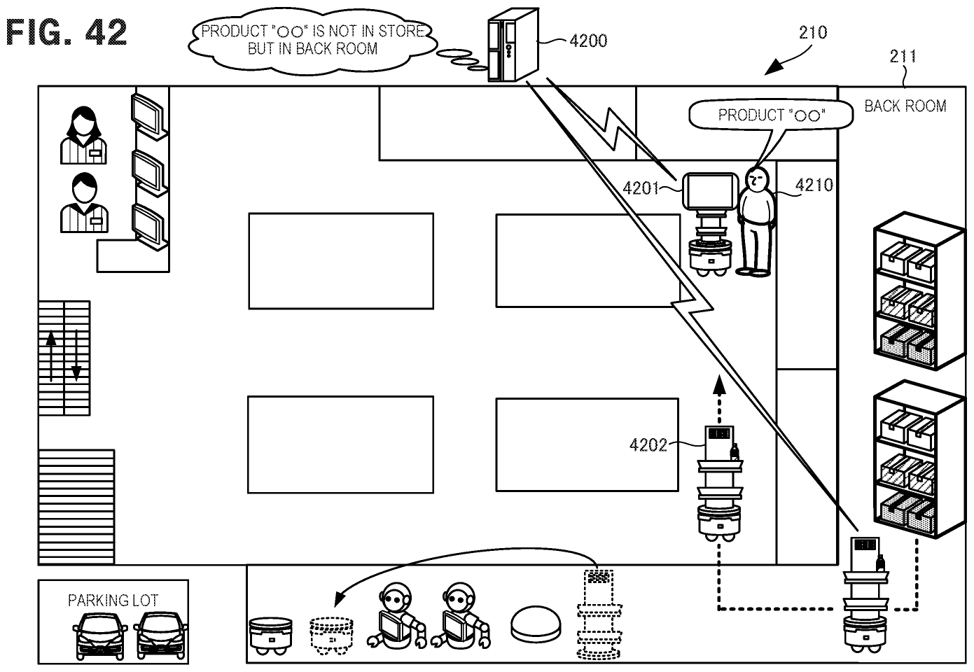

An information processing apparatus according to the 10th example embodiment of the present invention will be described next with reference to FIGS. 42 to 46. The information processing apparatus according to this example embodiment is different from those according to the above-described second to ninth example embodiments in that a request information acquirer and a request information analyzer are further provided. The remaining components and operations are similar to those in the second to ninth example embodiments. Hence, the same reference numerals denote similar components and operations, and a detailed description thereof will be omitted.

FIG. 42 is a view showing an example of processing by an information processing apparatus 4200 according to this example embodiment. Assume, for example, that a customer 4210 searches for a product “◯◯” using a voice search function with a customer guide robot 4201 moving in a store 210. Note that the customer 4210 may input a search word using a touch panel or the like instead of the voice search function.

In this case, since it is considered that the customer 4210 has a request to purchase the search product, the information processing apparatus 4200 acquires, from the customer guide robot 4201, search information (request information) input by the customer 4210.

The information processing apparatus 4200 analyzes the acquired search information to specify the search product (product “◯◯”) of the customer 4210. The information processing apparatus 4200 determines a stock status such as the presence or absence of stock of the specified search product. If, as a result of the determination processing, the product “◯◯” which the customer 4210 is searching for is not displayed in the store 210 but is in stock in a back room 211, a conveying robot 4202 having a conveyance function goes to the back room 211 to get the search product, and to bring it to the customer 4210.

The information processing apparatus 4200 detects the position of the customer 4210 based on the position information of the customer guide robot 4201 and the like. Note that the position information of the customer may be detected from, for example, image information acquired from the customer guide robot 4201.

Then, the information processing apparatus 4200 instructs the conveying robot 4202 to execute a work of picking up the product “◯◯” from the back room 211 and bringing it to the place where there is the customer 4210. Upon receiving the instruction, the conveying robot 4202 executes the work in accordance with instruction contents.

If the product which the customer 4210 is searching for is displayed in the store 210, the information processing apparatus 4200 may cause, for example, the customer guide robot 4201 to take the customer 4210 to a place where the product is displayed.

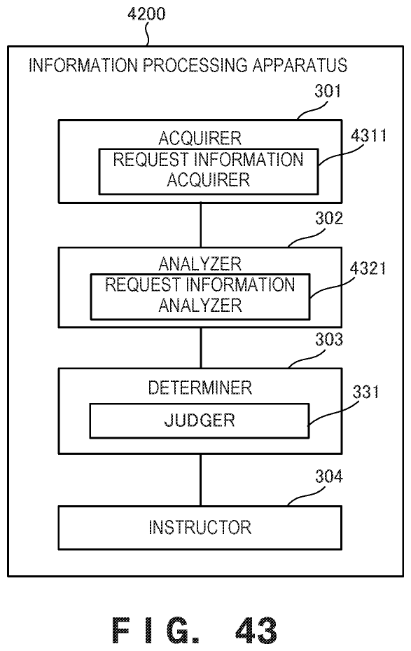

FIG. 43 is a block diagram showing the arrangement of the information processing apparatus 4200 according to this example embodiment. The information processing apparatus 4200 further includes a request information acquirer 4311 and a request information analyzer 4321. The request information acquirer 4311 acquires, from each robot, request information as information concerning the request of a customer.

The request information analyzer 4321 analyzes the acquired request information. For example, the request information analyzer 4321 analyzes, from the product search information of the customer 4210, a product which the customer 4210 desires to purchase. The request information analyzer 4321 further analyzes a place in the store 210, where the product searched for by the customer 4210 exists. If the product searched for by the customer 4210 is in the back room 211, an instructor 304 instructs the conveying robot 4202 to bring the product from the back room 211 to the customer 4210. If the product searched for by the customer 4210 is in the store 210, the instructor 304 instructs the customer guide robot 4201 to take the customer 4210.

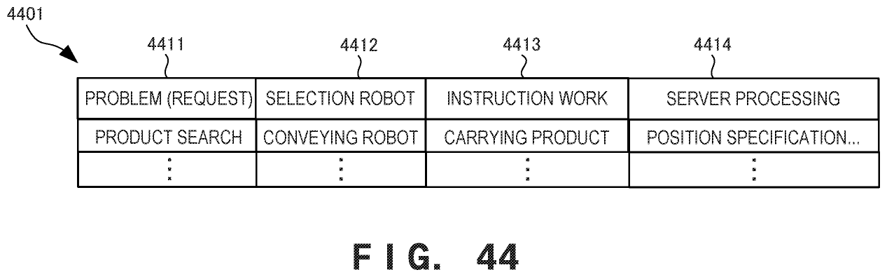

FIG. 44 is a table showing an example of a problem solving table 4401 provided in the information processing apparatus 4200 according to this example embodiment. The problem solving table 4401 stores, in association with a problem (request or product search) 4411, a selection robot 4412, an instruction work (carrying product) 4413, and server processing 4414. For example, the information processing apparatus 4200 executes a conveyance work of a product desired by a customer with reference to the problem solving table 4401.

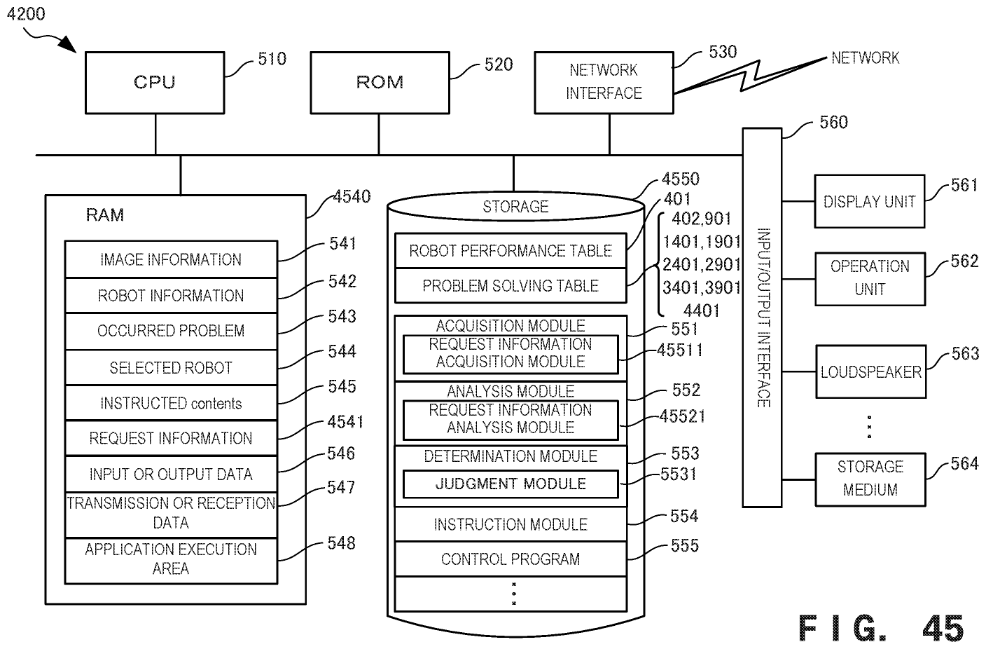

FIG. 45 is a block diagram showing the hardware arrangement of the information processing apparatus 4200 according to this example embodiment. A RAM 4540 is a random access memory used as a temporary storage work area by a CPU 510. An area to store data necessary for implementation of the example embodiment is allocated to the RAM 4540. Request information 4541 is information concerning the request of each customer. This data is loaded from, for example, the problem solving table 4401.

A storage 4550 stores a database, various parameters, or the following data or programs necessary for implementation of this example embodiment. The storage 4550 further stores the problem solving table 4401. The problem solving table 4401 is the table, shown in FIG. 44, for managing the relationship among the occurred problem (request) 4411, the selection robot 4412, and the like. The storage 4550 further stores a request information acquisition module 45511 and a request information analysis module 45521. The request information acquisition module 45511 is a module that acquires request information of a customer. The request information analysis module 45521 is a module that analyzes the acquired request information of the customer. These modules 45511 and 45521 are loaded to an application execution area 548 of the RAM 4540 and executed by the CPU 510. Note that programs and data that are associated with the general-purpose functions of the information processing apparatus 4200 and other feasible functions are not shown in the RAM 4540 or the storage 4550 of FIG. 45.

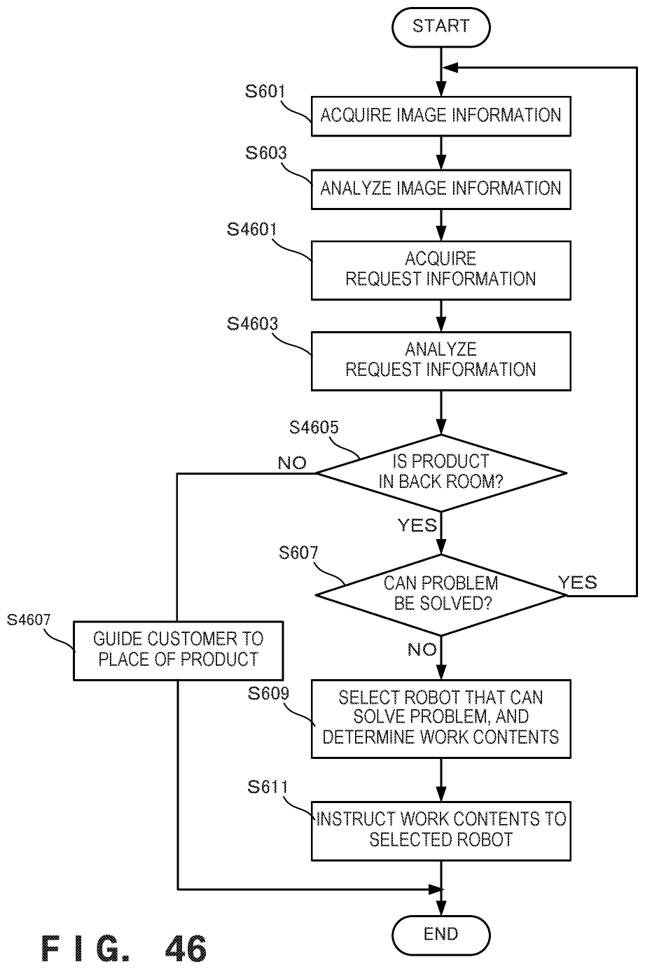

FIG. 46 is a flowchart for explaining the processing procedure of the information processing apparatus 4200 according to this example embodiment. This flowchart is executed by the CPU 510 using the RAM 4540, thereby implementing the functional components of the information processing apparatus 4200 shown in FIG. 43. In step S4601, the information processing apparatus 4200 acquires request information of the customer 4210. In step S4603, the information processing apparatus 4200 analyzes the acquired request information to specify a product searched for by the customer 4210. In step S4605, the information processing apparatus 4200 determines whether the product searched for by the customer 4210 is in the back room 211. If the product is not in the back room 211, the information processing apparatus 4200 advances to step S4607, and guides the customer 4210 to a place where there is the product. If the product exists not in the store 210 but in the back room 211, the information processing apparatus 4200 advances to the next step and makes the conveying robot 4202 bring the product.

According to this example embodiment, it is possible to surely bring, to a customer, a product desired by the customer. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### 11th Example Embodiment

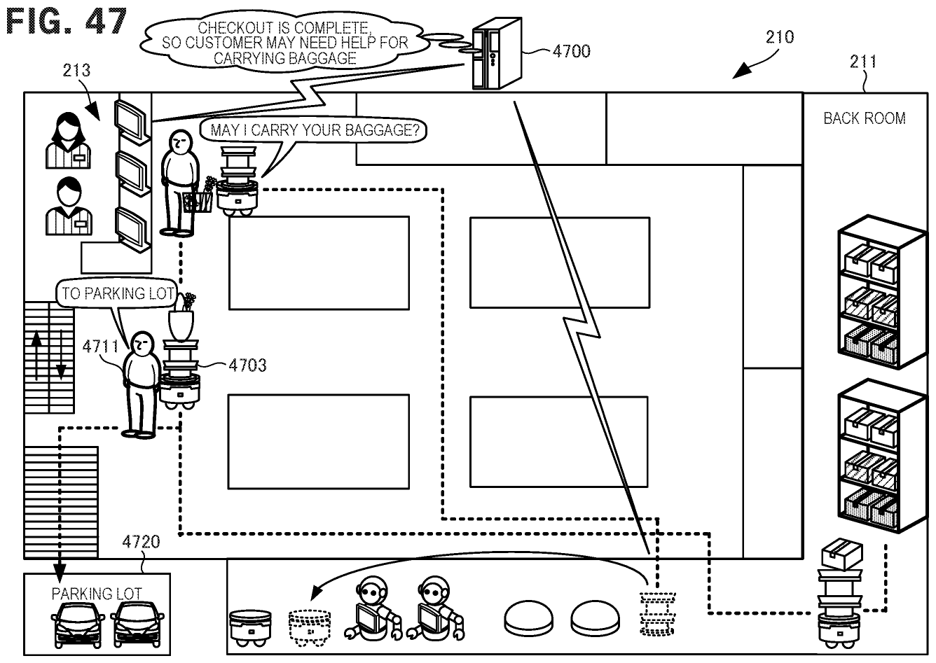

An information processing apparatus according to the 11th example embodiment of the present invention will be described next with reference to FIGS. 47 to 51. The information processing apparatus according to this example embodiment is different from those according to the above-described second to 10th example embodiments in that a conveyance necessity analyzer is further provided. The remaining components and operations are similar to those in the second to 10th example embodiments. Hence, the same reference numerals denote similar components and operations, and a detailed description thereof will be omitted.

FIG. 47 is a view showing another example of processing by an information processing apparatus 4700 according to this example embodiment. Assume, for example, that a customer 4711 pays for a purchase product at a register 213, and carries out the purchase product from a store 210. In this case, the information processing apparatus 4700 acquires checkout information of the customer 4711 from the register 213, and detects, from the acquired checkout information, that the customer 4711 has paid for the purchase product and is to go out from the store 210 soon. Note that the information processing apparatus 4700 may acquire checkout information of the customer from a checkout robot 704.

Then, the information processing apparatus 4700 sends, to the customer 4711 who leaves the register 213 to go outside, a conveying robot 4703 having a conveyance function of conveying the product purchased by the customer 4711, and acquires the presence or absence of a purchase product conveyance demand. Note that the information processing apparatus 4700 may determine, based on the number of products purchased by the customer 4711, the product weight, the product size, and the like, whether the customer 4711 has a purchase product conveyance demand, and send the conveying robot 4703 to the customer 4711. For example, the information processing apparatus 4700 compares the number of purchased products, the product weight, and the product size with predetermined thresholds, respectively, and if at least one of them exceeds the corresponding predetermined threshold, the information processing apparatus 4700 sends the conveying robot 4703 to the customer 4711. Note that the information processing apparatus 4700 may acquire the number of purchase products, the purchase product weight, the purchase product size, and the like from a POS (Point Of Sales) terminal at the register 213 or the like.

The information processing apparatus 4700 acquires the conveyance demand of the customer 4711 from the conveying robot 4703, and analyzes the acquired conveyance demand, thereby detecting the demand of the customer 711. If the information processing apparatus 4700 detects, as the demand of the customer 4711, conveyance of the purchase product of the customer 4711 to a parking lot 4720, the information processing apparatus 4700 instructs the conveying robot 4703 to execute a work of conveying the product purchased by the customer 4711 to the parking lot 4720. Note that a display unit of the conveying robot 4703 may be provided, and destination display buttons may be displayed on the display unit, thereby acquiring the request of the customer 4711. Examples of the destination display buttons are buttons of “exit of store”, “parking lot”, and “following”, but the present invention is not limited to them.

If a product to be purchased by the customer 4711 is a large product or a heavy product, the customer 4711 brings, for example, a product purchase card to the register 213 to perform a purchase procedure. Upon detecting completion of checkout of the customer 4711 based on information from the register 213, the information processing apparatus 4700 instructs the conveying robot 4703 to convey the product from a back room 211 to the customer 4711. Then, the information processing apparatus 4700 acquires, from the conveying robot 4703, the request of the customer 4711 to convey the product to a specific place. The information processing apparatus 4700 instructs the conveying robot 4703 to execute a work of conveying the product of the customer.

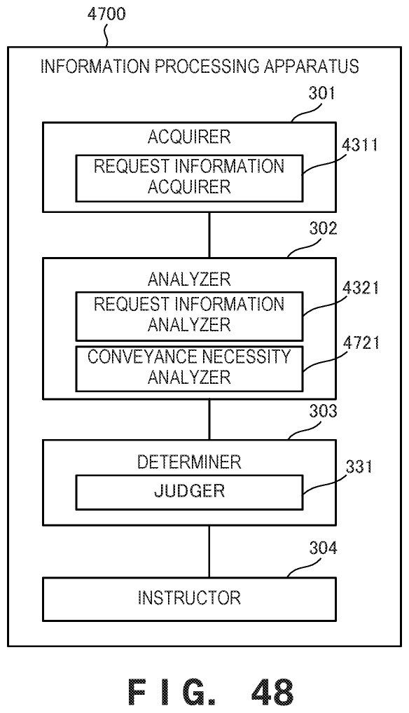

FIG. 48 is a block diagram showing the arrangement of the information processing apparatus 4700 according to this example embodiment. The information processing apparatus 4700 further includes a conveyance necessity analyzer 4721. The conveyance necessity analyzer 4721 sends the conveying robot 4703 to the customer 4711 by comparing the amount (baggage quantity) of products purchased by the customer 4711 with a predetermined threshold. The baggage quantity is, for example, the purchased product weight, the number of purchased products, or the purchased product size. These data are compared with the predetermined thresholds, respectively. If at least one of these data exceeds the corresponding predetermined threshold, the conveyance necessity analyzer 4721 sends the conveying robot 4703 to the customer 4711.

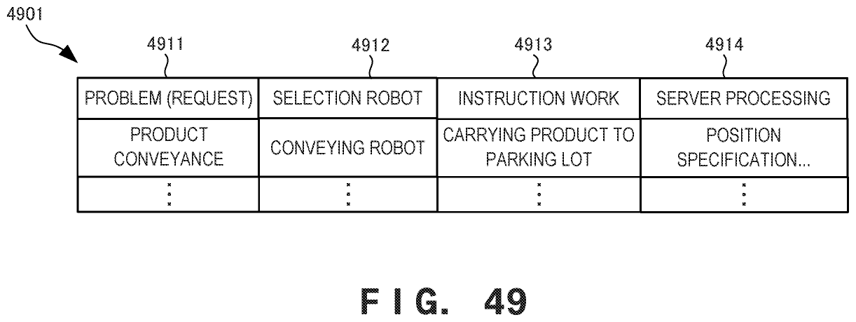

FIG. 49 is a table showing an example of a problem solving table 4901 provided in the information processing apparatus 4700 according to this example embodiment. The problem solving table 4901 stores, in association with a problem (request) 4911, a selection robot 4912, an instruction work (for example, carrying product to parking lot) 4913, and server processing 4914. For example, the information processing apparatus 4700 executes a conveyance work of a product requested by a customer with reference to the problem solving table 4901.

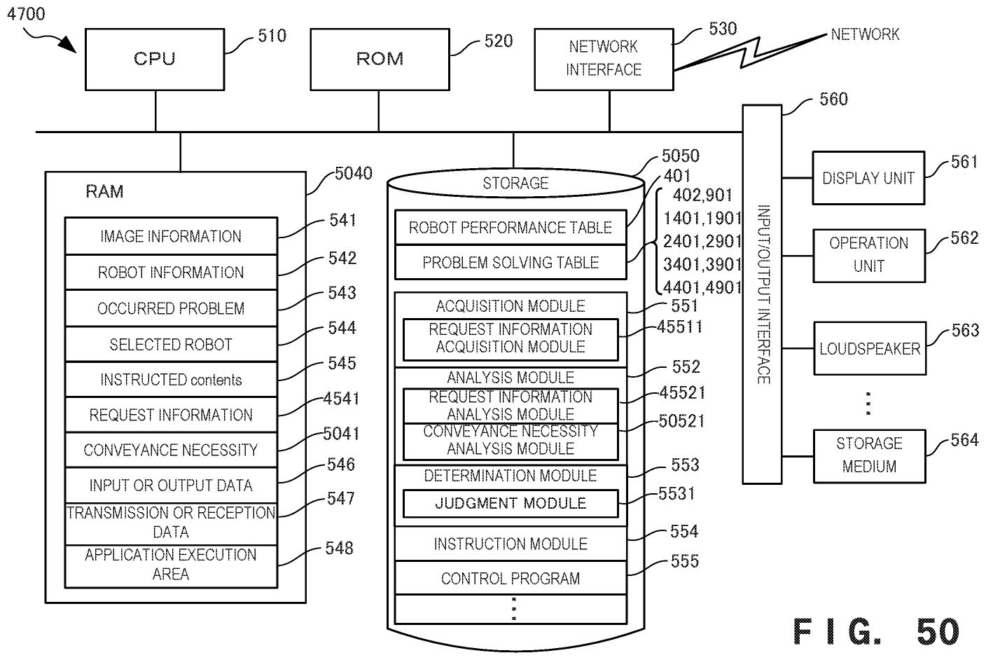

FIG. 50 is a block diagram showing the hardware arrangement of the information processing apparatus 4700 according to this example embodiment. A RAM 5040 is a random access memory used as a temporary storage work area by a CPU 510. An area to store data necessary for implementation of the example embodiment is allocated to the RAM 5040. Request information 4541 is information concerning the request of each customer, for example, including conveyance necessity 5041 by the customer 4711. This data is loaded from, for example, the problem solving table 4901.

A storage 5050 stores a database, various parameters, or the following data or programs necessary for implementation of this example embodiment. The storage 5050 further stores the problem solving table 4901. The problem solving table 4901 is the table, shown in FIG. 49, for managing the relationship among the occurred problem (request) 4911, the selection robot 4912, and the like. The storage 5050 further stores a conveyance necessity analysis module 50521. The conveyance necessity analysis module 50521 is a module that analyzes, based on the baggage quantity of the customer 4711, whether it is necessary to send the conveying robot 4703 to the customer 4711. This module 50521 is loaded to an application execution area 548 of the RAM 5040 and executed by the CPU 510. Note that programs and data that are associated with the general-purpose functions of the information processing apparatus 4700 and other feasible functions are not shown in the RAM 5040 or the storage 5050 of FIG. 50.

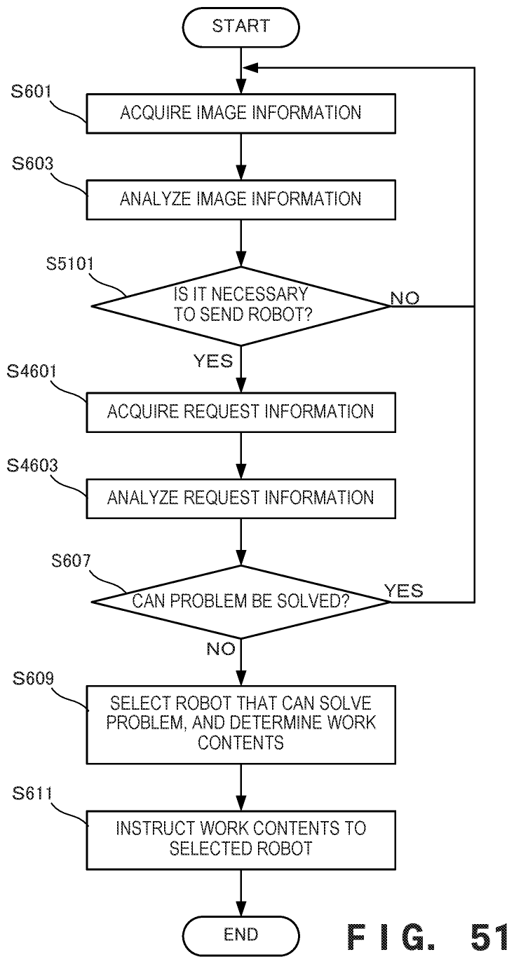

FIG. 51 is a flowchart for explaining the processing procedure of the information processing apparatus 4700 according to this example embodiment. This flowchart is executed by the CPU 510 using the RAM 5040, thereby implementing the functional components of the information processing apparatus 4700 shown in FIG. 47. In step S5101, the information processing apparatus 4700 determines whether or not to send the conveying robot 4703 to the customer 4711 by comparing the weight of the product purchased by the customer 4711, the number of purchased products, the size of the purchased product, and the like with the predetermined thresholds. If it is unnecessary to send the conveying robot 4703, the information processing apparatus 4700 returns to step S601. If it is necessary to send the conveying robot 4703, the information processing apparatus 4700 advances to the next step, and analyzes the request of the customer 4711.

According to this example embodiment, since a conveying robot is sent in accordance with the baggage quantity of a customer, it is possible to appropriately assist the customer who has a product conveyance demand. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### 12th Example Embodiment

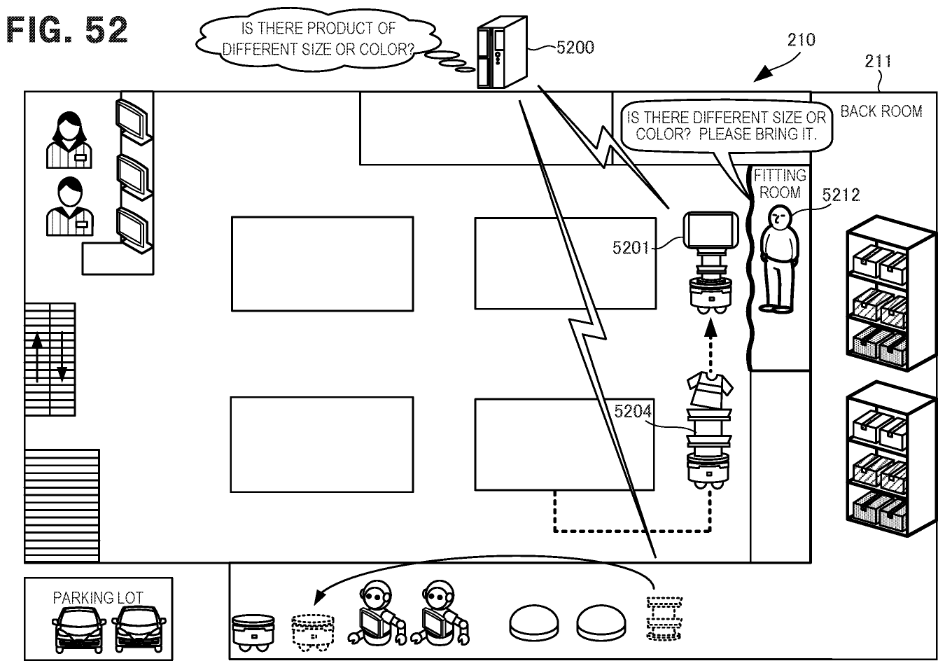

An information processing apparatus according to the 12th example embodiment of the present invention will be described next with reference to FIGS. 52 to 56. The information processing apparatus according to this example embodiment is different from those according to the above-described second to 11th example embodiments in that an alternative product analyzer is further provided. The remaining components and operations are similar to those in the second to 11th example embodiments. Hence, the same reference numerals denote similar components and operations, and a detailed description thereof will be omitted.

FIG. 52 is a view showing another example of processing by an information processing apparatus 5200 according to this example embodiment. Assume, for example, that a customer 5212 who is trying on a product in a fitting room makes a request to the order-taking robot 5201 to bring a product of a different size or color, as shown in FIG. 52.

While the customer 5212 tries on a product in the fitting room, the order-taking robot 5201 stands by in front of the fitting room. If, as a result of the try-on, the try-on product is different from the image of the customer or the size does not fit, the customer 5212 requests the order-taking robot 5201 standing by outside the fitting room to bring another product. The customer 5212 makes a request by voice input to the order-taking robot 5201.

The information processing apparatus 5200 acquires the request of the customer 5212 from the order-taking robot 5201, and analyzes the request. The request of the customer 5212 is, for example, to bring a product of a different size, different color, or different pattern to the fitting room.

The information processing apparatus 5200 analyzes a place where there exists a product meeting the request of the customer 5212. That is, the information processing apparatus 5200 analyzes whether the requested product is in a store 210 or a back room 211. If the product requested by the customer 5212 is in the store 210, the information processing apparatus 5200 causes a conveying robot 5204 to go to the requested product in the store 210 and bring the requested product to the fitting room (or designated place). Alternatively, if the product requested by the customer 5212 is in the back room 211, the information processing apparatus 5200 causes the conveying robot 5204 to go to the back room 211 for the requested product and bring the requested product from the back room 211 to the fitting room. Note that if the product is in the back room 211, the conveying robot 5204 standing by in the back room 211 may bring the requested product from the back room 211 to the fitting room.

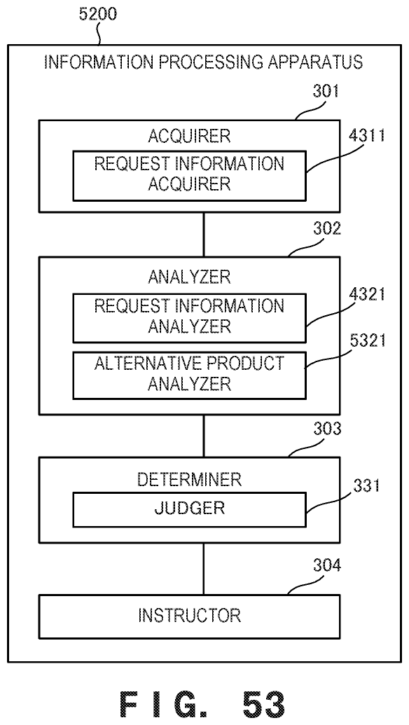

FIG. 53 is a block diagram showing the arrangement of the information processing apparatus 5200 according to this example embodiment. The information processing apparatus 5200 further includes an alternative product analyzer 5321. The alternative product analyzer 5321 analyzes an alternative product of the try-on product which the customer 5212 has tried on. For example, the alternative product analyzer 5321 analyzes a place in the store 210 where there exists a product of a different size or a different color requested by the customer 5212. Then, an instructor 304 issues, to the conveying robot 5204, an instruction corresponding to the place where there exists the product requested by the customer 5212.

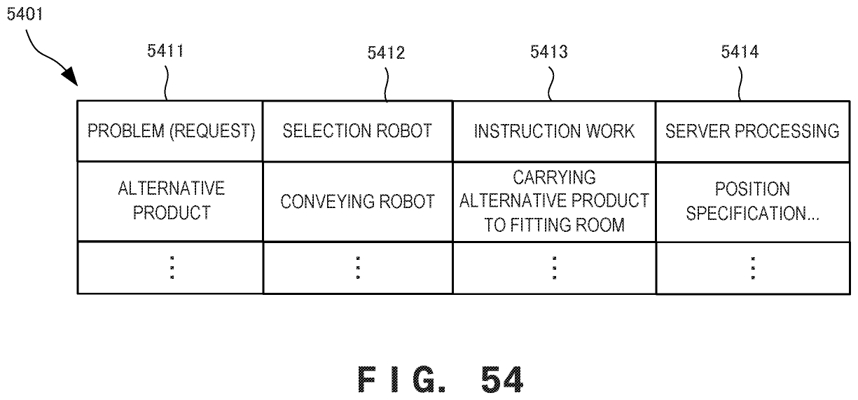

FIG. 54 is a table showing an example of a problem solving table 5401 provided in the information processing apparatus 5200 according to this example embodiment. The problem solving table 5401 stores, in association with a problem (request) 5411, a selection robot 5412, an instruction work (carrying alternative product to fitting room) 5413, and server processing 5414. For example, the information processing apparatus 5200 executes a conveyance work of a product requested by a customer with reference to the problem solving table 5401.

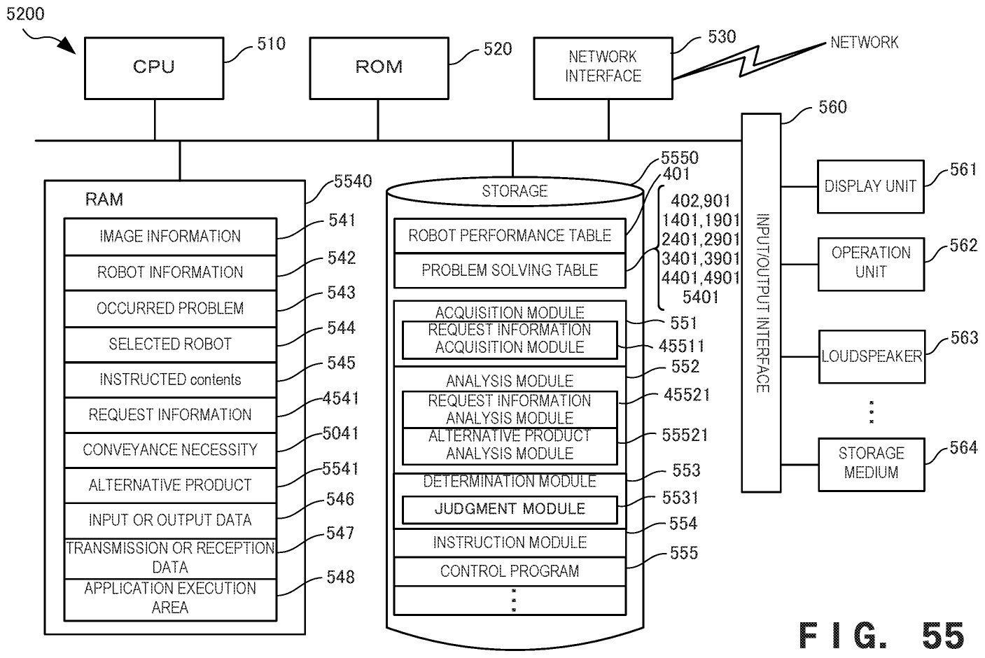

FIG. 55 is a block diagram showing the hardware arrangement of the information processing apparatus 5200 according to this example embodiment. A RAM 5540 is a random access memory used as a temporary storage work area by a CPU 510. An area to store data necessary for implementation of the example embodiment is allocated to the RAM 5540. An alternative product 5541 is, for example, a product of a different size or a different color requested by the customer 5212. This data is loaded from, for example, the problem solving table 5401.

A storage 5550 stores a database, various parameters, or the following data or programs necessary for implementation of this example embodiment. The storage 5550 further stores the problem solving table 5401. The problem solving table 5401 is the table, shown in FIG. 54, for managing the relationship among the occurred problem (request) 5411, the selection robot 5412, and the like. The storage 5550 further stores an alternative product analysis module 55521. The alternative product analysis module 55521 is a module that analyzes an alternative product of a try-on product which the customer 5212 has tried on. This module 55521 is loaded to an application execution area 548 of the RAM 5540 and executed by the CPU 510. Note that programs and data that are associated with the general-purpose functions of the information processing apparatus 5200 and other feasible functions are not shown in the RAM 5540 or the storage 5550 of FIG. 55.

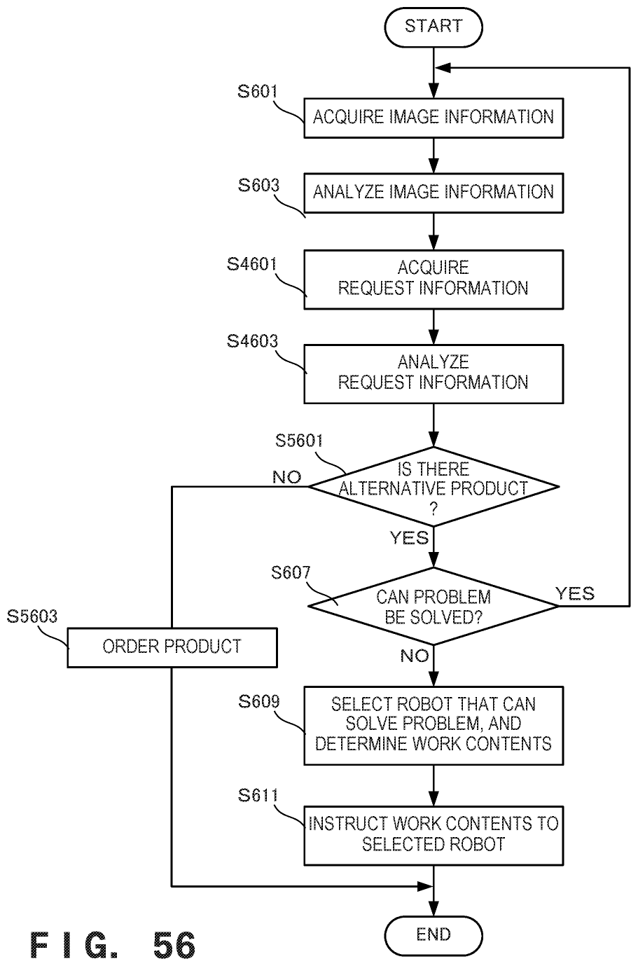

FIG. 56 is a flowchart for explaining the processing procedure of the information processing apparatus 5200 according to this example embodiment. This flowchart is executed by the CPU 510 using the RAM 5540, thereby implementing the functional components of the information processing apparatus 5200 shown in FIG. 52. In step S5601, the information processing apparatus 5200 determines whether an alternative product of the product which the customer 5212 has tried on is in the store 210 or the back room 211. If the alternative product is neither in the store 210 nor the back room 211, the information processing apparatus 5200 advances to step S5603, and performs an order work of the product and the like, thereby ending the processing. If the alternative product is in the store 210 or the back room 211, the information processing apparatus 5200 advances to the next step. Then, the information processing apparatus 5200 instructs the conveying robot 5204 to bring the alternative product to the customer 5212.

According to this example embodiment, even if there is no employee, a customer can freely try on a product. Thus, each employee need not be devote to one customer, and can perform another work, thereby making it possible to improve the work efficiency. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### 13th Example Embodiment

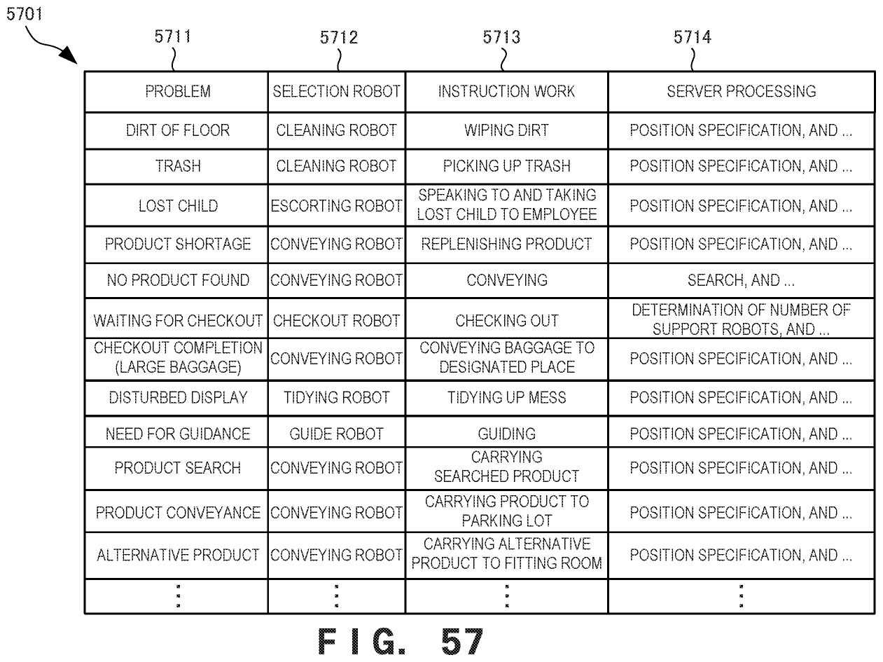

An information processing apparatus according to the 13th example embodiment of the present invention will be described next with reference to FIG. 57. The information processing apparatus according to this example embodiment is different from those according to the above-described second to 12th example embodiments in that a problem solving table is provided. The remaining components and operations are similar to those in the second to 12th example embodiments. Hence, the same reference numerals denote similar components and operations, and a detailed description thereof will be omitted. The information processing apparatus according to this example embodiment is, for example, an apparatus that can operate various types of robots in one store 210.

FIG. 57 is a table showing an example of a problem solving table provided in the information processing apparatus according to this example embodiment. A problem solving table 5701 stores, in association with a problem 5711, a selection robot 5712, an instruction work 5713, and server processing 5714. The information processing apparatus instructs works to various types of robots with reference to the problem solving table 5701. The problem solving table 5701 is stored in, for example, the storage of the information processing apparatus, and is loaded to a RAM, as needed.

According to this example embodiment, even if it is necessary to operate various types of robots, case classification when assigning instructions to the respective robots is simple, and thus the system configuration is also simple. A plurality of robots can cooperate to cope with a problem occurring outside a robot. Furthermore, a robot can automatically solve a problem occurring in a store without intervention of an operator. In addition, since it is unnecessary to interpose any operator, it is also possible to reduce the operation cost of a system.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims. A system or apparatus including any combination of the individual features included in the respective example embodiments may be incorporated in the scope of the present invention.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described example embodiments can also be described as in the following supplementary notes but are not limited to the followings.

(Supplementary Note 1)

There is provided an information processing apparatus comprising:

an acquirer that acquires information from a first robot;

an analyzer that analyzes the acquired information;

a determiner that determines a second robot to cooperate with the first robot and work contents of the second robot based on an analysis result of the analyzer; and

an instructor that instructs the work contents to the second robot based on a determination result of the determiner.

(Supplementary Note 2)

There is provided the information processing apparatus according to supplementary note 1, wherein said determiner comprises a judger that judges whether or not the first robot can solve a problem occurring in a store, and, if said judger has judged that the first robot cannot solve the problem, determines the second robot that can solve the problem.

(Supplementary Note 3)

There is provided the information processing apparatus according to supplementary note 1 or 2, wherein the first robot and the second robot execute a work in a store,

said acquirer acquires image information from the first robot,

said analyzer analyzes the image information to detect the problem occurring in the store,

said determiner determines the second robot that can solve the detected problem, and

said instructor instructs the work contents for solving the detected problem to the second robot.

(Supplementary Note 4)

There is provided the information processing apparatus according to supplementary note 3, wherein said analyzer analyzes the image information to detect a dirt of a floor and position information of the dirt,

said determiner determines, as the second robot, a cleaning robot that cleans the detected dirt of the floor, and a cleaning method as the work contents to be performed by the cleaning robot, and

said instructor instructs the position information of the dirt and the cleaning method to the cleaning robot.

(Supplementary Note 5)

There is provided the information processing apparatus according to supplementary note 3 or 4, wherein said analyzer analyzes the image information to detect a number of customers waiting for checkout and position information for checkout,

said determiner determines, as the second robot, a checkout robot having a checkout function for checking out the customers waiting for checkout, if the number of the customers exceeds a first threshold, and

said instructor instructs the position information for checkout and execution of the checkout function to the checkout robot.

(Supplementary Note 6)

There is provided the information processing apparatus according to any one of supplementary notes 3 to 5, wherein said analyzer analyzes the image information to recognize a display state of products on a shelf, and detect product shortage and position information of the product shortage based on the display state,

said determiner determines, as the second robot, a product replenishing robot having a replenishing function of replenishing the product for which the product shortage has been detected, and

said instructor instructs the position information of the product shortage and execution of the replenishing function to the product replenishing robot.

(Supplementary Note 7)

There is provided the information processing apparatus according to any one of supplementary notes 3 to 6, wherein said analyzer analyzes the image information to detect a customer who needs a guidance and position information of the customer,

said determiner determines, as the second robot, a customer guide robot having a customer guidance function, and

said instructor instructs the position information of the customer and execution of the customer guide function to the customer guide robot.

(Supplementary Note 8)

There is provided the information processing apparatus according to any one of supplementary notes 3 to 7, wherein said analyzer analyzes the image information to recognize a display state of a product, and detect a disturbed display of the product and position information of the disturbed display based on the display state,

said determiner determines, as the second robot, a tidying robot having a tidying function of tidying up the disturbed display, and

said instructor instructs the position information of the disturbed display and execution of the tidying function to the tidying robot.

(Supplementary Note 9)

There is provided the information processing apparatus according to any one of supplementary notes 3 to 8, wherein said analyzer analyzes the image information to detect position information of the first robot and a transportation state of products by the first robot,

said determiner determines, as the second robot, a transportation robot having a transportation function of the products, if a transportation amount of the products exceeds a second threshold, and

said instructor instructs the position information of the first robot and execution of the transportation function to the transportation robot.

(Supplementary Note 10)

There is provided the information processing apparatus according to any one of supplementary notes 3 to 9, wherein said analyzer analyzes the image information to detect a lost child and position information of the lost child,

said determiner determines, as the second robot, a escorting robot having a escorting function of escorting the lost child, and

said instructor instructs the position information of the lost child and execution of the escorting function to the escorting robot.

(Supplementary Note 11)

There is provided the information processing apparatus according to any one of supplementary notes 3 to 10, wherein said analyzer analyzes the image information to detect a lost property and position information of the lost property,

said determiner determines, as the second robot, a collecting robot having a collection function of collecting the lost property, and

said instructor instructs the position information of the lost property and execution of the collection function to the collecting robot.

(Supplementary Note 12)

There is provided the information processing apparatus according to supplementary note 1 or 2, wherein said acquirer further acquires request information of a customer from the first robot,

said analyzer further analyzes the acquired request information, and

said determiner determines the second robot to cooperate with the first robot and the work contents the second robot based on further an analysis result of the request information.

(Supplementary Note 13)

There is provided the information processing apparatus according to supplementary note 12, wherein said analyzer analyzes the request information to recognize product search information of a customer, and detect a stock status of a search product and position information of the customer from the product search information,

said determiner determines, as the second robot, a conveying robot having a conveyance function of the search product, and

said instructor instructs the position information of the customer and execution of the conveyance function to the conveying robot.

(Supplementary Note 14)

There is provided the information processing apparatus according to supplementary note 12 or 13, wherein said analyzer analyzes the request information to detect purchase product conveyance request of a customer and position information of the customer,

said determiner determines, as the second robot, a conveying robot having a conveyance function of conveying purchased products, and

said instructor instructs the position information of the customer and execution of the conveyance function to the conveying robot.

(Supplementary Note 15)

There is provided the information processing apparatus according to any one of supplementary notes 12 to 14, wherein said analyzer analyzes the request information to detect information concerning an alternative product of a product which a customer is trying on, and position information of the customer,

said determiner determines, as the second robot, a conveying robot having a conveyance function of conveying the alternative product, and

said instructor instructs the position information of the customer and execution of the conveyance function to the conveying robot.

(Supplementary Note 16)

There is provided an information processing method comprising:

acquiring information from a first robot;

analyzing the acquired information;

determining a second robot to cooperate with the first robot and work contents of the second robot based on an analysis result in the analyzing; and

instructing the work contents to the second robot based on a determination result in the determining.

(Supplementary Note 17)

There is provided an information processing program for causing a computer to execute a method, comprising:

acquiring information from a first robot;

analyzing the acquired information;

determining a second robot to cooperate with the first robot and work contents of the second robot based on an analysis result in the analyzing; and

instructing the work contents to the second robot based on a determination result in the determining.

1. An information processing apparatus comprising:
an acquirer that acquires information from a first robot;
an analyzer that analyzes the acquired information;
a determiner that determines a second robot to cooperate with the first robot and work contents of the second robot based on an analysis result of the analyzer; and
an instructor that instructs the work contents to the second robot based on a determination result of the determiner.

2. The information processing apparatus according to claim 1, wherein said determiner comprises a judger that judges whether or not the first robot can solve a problem occurring in a store, and, if said judger has judged that the first robot cannot solve the problem, determines the second robot that can solve the problem.

3. The information processing apparatus according to claim 1,
wherein the first robot and the second robot execute a work in a store,
said acquirer acquires image information from the first robot,
said analyzer analyzes the image information to detect the problem occurring in the store,
said determiner determines the second robot that can solve the detected problem, and
said instructor instructs the work contents for solving the detected problem to the second robot.

4. The information processing apparatus according to claim 3, wherein said analyzer analyzes the image information to detect a dirt of a floor and position information of the dirt,
said determiner determines, as the second robot, a cleaning robot that cleans the detected dirt of the floor, and a cleaning method as the work contents to be performed by the cleaning robot, and
said instructor instructs the position information of the dirt and the cleaning method to the cleaning robot.

5. The information processing apparatus according to claim 3, wherein said analyzer analyzes the image information to detect a number of customers waiting for checkout and position information for checkout,
said determiner determines, as the second robot, a checkout robot having a checkout function for checking out the customers waiting for checkout, if the number of the customers exceeds a first threshold, and
said instructor instructs the position information for checkout and execution of the checkout function to the checkout robot.

6. The information processing apparatus according to claim 3, wherein said analyzer analyzes the image information to recognize a display state of products on a shelf, and detect product shortage and position information of the product shortage based on the display state,
said determiner determines, as the second robot, a product replenishing robot having a replenishing function of replenishing the product for which the product shortage has been detected, and
said instructor instructs the position information of the product shortage and execution of the replenishing function to the product replenishing robot.

7. The information processing apparatus according to claim 3, wherein said analyzer analyzes the image information to detect a customer who needs a guidance and position information of the customer,
said determiner determines, as the second robot, a customer guide robot having a customer guidance function, and
said instructor instructs the position information of the customer and execution of the customer guide function to the customer guide robot.

8. The information processing apparatus according to claim 3, wherein said analyzer analyzes the image information to recognize a display state of a product, and detect a disturbed display of the product and position information of the disturbed display based on the display state,
said determiner determines, as the second robot, a tidying robot having a tidying function of tidying up the disturbed display, and
said instructor instructs the position information of the disturbed display and execution of the tidying function to the tidying robot.

9. The information processing apparatus according to claim 3, wherein said analyzer analyzes the image information to detect position information of the first robot and a transportation state of products by the first robot,
said determiner determines, as the second robot, a transportation robot having a transportation function of the products, if a transportation amount of the products exceeds a second threshold, and
said instructor instructs the position information of the first robot and execution of the transportation function to the transportation robot.

10. The information processing apparatus according to claim 3, wherein said analyzer analyzes the image information to detect a lost child and position information of the lost child,
said determiner determines, as the second robot, a escorting robot having a escorting function of escorting the lost child, and
said instructor instructs the position information of the lost child and execution of the escorting function to the escorting robot.

11. The information processing apparatus according to claim 3, wherein said analyzer analyzes the image information to detect a lost property and position information of the lost property,
said determiner determines, as the second robot, a collecting robot having a collection function of collecting the lost property, and
said instructor instructs the position information of the lost property and execution of the collection function to the collecting robot.

12. The information processing apparatus according to claim 1, wherein said acquirer further acquires request information of a customer from the first robot,
said analyzer further analyzes the acquired request information, and
said determiner determines the second robot to cooperate with the first robot and the work contents the second robot based on further an analysis result of the request information.

13. The information processing apparatus according to claim 12, wherein said analyzer analyzes the request information to recognize product search information of a customer, and detect a stock status of a search product and position information of the customer from the product search information,
said determiner determines, as the second robot, a conveying robot having a conveyance function of the search product, and
said instructor instructs the position information of the customer and execution of the conveyance function to the conveying robot.

14. The information processing apparatus according to claim 12, wherein said analyzer analyzes the request information to detect purchase product conveyance request of a customer and position information of the customer,
said determiner determines, as the second robot, a conveying robot having a conveyance function of conveying purchased products, and
said instructor instructs the position information of the customer and execution of the conveyance function to the conveying robot.

15. The information processing apparatus according to claim 12, wherein said analyzer analyzes the request information to detect information concerning an alternative product of a product which a customer is trying on, and position information of the customer,
said determiner determines, as the second robot, a conveying robot having a conveyance function of conveying the alternative product, and
said instructor instructs the position information of the customer and execution of the conveyance function to the conveying robot.

16. An information processing method comprising:
acquiring information from a first robot;
analyzing the acquired information;
determining a second robot to cooperate with the first robot and work contents of the second robot based on an analysis result in the analyzing; and
instructing the work contents to the second robot based on a determination result in the determining.

17. A non-transitory computer-readable storage medium storing an information processing program for causing a computer to execute a method, comprising:
acquiring information from a first robot;
analyzing the acquired information;
determining a second robot to cooperate with the first robot and work contents of the second robot based on an analysis result in the analyzing; and
instructing the work contents to the second robot based on a determination result in the determining.

18. An information robot to execute a work in a store,
said information processing apparatus according to claim 2, wherein the second robot acquires image information from the first robot,
said analyzer analyzes the image information to detect the problem occurring in the store,
said determiner determines the second robot that can solve the detected problem, and
said instructor instructs the work contents for solving the detected problem to the second robot.

19. The information processing apparatus according to claim 2, wherein said acquirer further acquires request information of a customer from the first robot,
said analyzer further analyzes the acquired request information, and
said determiner determines the second robot to cooperate with the first robot and instructs the work contents to the second robot based on further an analysis result of the request information.
